(19) United States
(12) Patent Application Publication
(10) Pub. No.: US 2026/0222248 A1
(43) Pub. Date: Jul. 30, 2026

(54) DIFFERENTIAL CHANNEL CHARACTERISTIC VALUE PREDICTION REPORT FOR USER EQUIPMENT (UE)-SIDE BEAM PREDICTION

(71) Applicant: QUALCOMM Incorporated, San Diego, CA (US)

(72) Inventors: Qiaoyu LI, Beijing (CN); Mahmoud TAHERZADEH BOROUJENI, San Diego, CA (US); Hamed PEZESHKI, San Diego, CA (US)

(21) Appl. No.: 19/146,115

(22) PCT Filed: Feb. 17, 2023
(86) PCT No.: PCT/CN2023/076678

§ 371 Date: Jul. 7, 2025

(51) Int. Cl. H04L 25/02; H04B 7/0408

(52) U.S. Cl. CPC H04L 25/0224; H04B 7/0408

(57) ABSTRACT

Certain aspects of the present disclosure provide a method for wireless communications at a user equipment (UE). The UE may receive (910) a configuration for a plurality of resources corresponding to a plurality of beams. The UE may transmit (910) signaling indicating a report that indicates channel characteristic values associated with a subset of resources of the plurality of resources where each resource of the subset of resources is associated with a channel characteristic value that is lower than a reference channel characteristic value associated with a reference resource of the plurality of resources.

### BACKGROUND

### Field of the Disclosure

Aspects of the present disclosure relate to wireless communications, and more particularly, to techniques for managing and reporting channel characteristic values corresponding to different beams.

### Description of Related Art

Wireless communications systems are widely deployed to provide various telecommunication services such as telephony, video, data, messaging, broadcasts, or other similar types of services. These wireless communications systems may employ multiple-access technologies capable of supporting communications with multiple users by sharing available wireless communications system resources with those users.

Although wireless communications systems have made great technological advancements over many years, challenges still exist. For example, complex and dynamic environments can still attenuate or block signals between wireless transmitters and wireless receivers. Accordingly, there is a continuous desire to improve the technical performance of wireless communications systems, including, for example: improving speed and data carrying capacity of communications, improving efficiency of the use of shared communications mediums, reducing power used by transmitters and receivers while performing communications, improving reliability of wireless communications, avoiding redundant transmissions and/or receptions and related processing, improving the coverage area of wireless communications, increasing the number and types of devices that can access wireless communications systems, increasing the ability for different types of devices to intercommunicate, increasing the number and type of wireless communications mediums available for use, and the like. Consequently, there exists a need for further improvements in wireless communications systems to overcome the aforementioned technical challenges and others.

### SUMMARY

One aspect provides a method for wireless communications at a user equipment (UE). The method includes obtaining a configuration for a plurality of resources corresponding to a plurality of beams. The method further includes outputting, for transmission, signaling indicating a report that indicates channel characteristic values associated with a subset of resources of the plurality of resources, wherein each resource of the subset of resources is associated with a channel characteristic value that is lower than a reference channel characteristic value associated with a reference resource of the plurality of resources, and wherein each channel characteristic value associated with at least one of the plurality of resources is based on a measurement prediction of one or more channel characteristics associated with the at least one of the plurality of resources.

Another aspect provides a method for wireless communications at a network entity. The method includes outputting, for transmission, a configuration for a plurality of resources corresponding to a plurality of beams. The method further includes obtaining signaling indicating a report that indicates channel characteristic values associated with a subset of resources of the plurality of resources, wherein each resource of the subset of resources is associated with a channel characteristic value that is lower than a reference channel characteristic value associated with a reference resource of the plurality of resources, and wherein each channel characteristic value associated with at least one of the plurality of resources is based on a measurement prediction of one or more channel characteristics associated with the at least one of the plurality of resources.

Another aspect provides a method for wireless communications at a UE. The method includes obtaining a configuration for a plurality of resources corresponding to a plurality of beams, wherein each of the plurality of resources is associated with an identification (ID). The method further includes outputting, for transmission, signaling indicating a report that indicates IDs of at least some of the plurality of resources, each of the at least some of the plurality of resources being associated with a channel characteristic value that exceeds a threshold, and wherein each channel characteristic value associated with at least one of the plurality of resources is based on a measurement prediction of one or more channel characteristics associated with the at least one of the plurality of resources.

Another aspect provides a method for wireless communications at a network entity. The method includes outputting, for transmission, a configuration for a plurality of resources corresponding to a plurality of beams, wherein each of the plurality of resources is associated with an ID. The method further includes obtaining signaling indicating a report that indicates IDs of at least some of the plurality of resources, each of the at least some of the plurality of resources being associated with a channel characteristic value that exceeds a threshold, and wherein each channel characteristic value associated with at least one of the plurality of resources is based on a measurement prediction of one or more channel characteristics associated with the at least one of the plurality of resources.

Other aspects provide: an apparatus operable, configured, or otherwise adapted to perform the aforementioned methods as well as those described elsewhere herein; a non-transitory, computer-readable media comprising instructions that, when executed by a processor of an apparatus, cause the apparatus to perform the aforementioned methods as well as those described elsewhere herein; a computer program product embodied on a computer-readable storage medium comprising code for performing the aforementioned methods as well as those described elsewhere herein; and an apparatus comprising means for performing the aforementioned methods as well as those described elsewhere herein. By way of example, an apparatus may comprise a processing system, a device with a processing system, or processing systems cooperating over one or more networks.

The following description and the appended figures set forth certain features for purposes of illustration.

### BRIEF DESCRIPTION OF DRAWINGS

The appended figures depict certain features of the various aspects described herein and are not to be considered limiting of the scope of this disclosure.

FIG. 1 depicts an example wireless communications network.

FIG. 2 depicts an example disaggregated base station (BS) architecture.

FIG. 3 depicts aspects of an example BS and an example user equipment (UE).

FIGS. 4A, 4B, 4C, and 4D depict various example aspects of data structures for a wireless communications network.

FIG. 5 depicts example beam refinement procedures.

FIG. 6 depicts example beam management procedure.

FIG. 7 depicts a call flow diagram illustrating example communication among a UE and a network entity.

FIG. 8 depicts example determination of differential layer one reference signal received power (L1-RSRP) values or layer one signal to interference noise ratio (L1-SINR) values associated with a subset of resources.

FIG. 9 depicts a method for wireless communications at a UE.

FIG. 10 depicts a method for wireless communications at a network entity.

FIG. 11 depicts another call flow diagram illustrating example communication among a UE and a network entity.

FIG. 12 depicts example content of a report indicating for each resource whether their associated L1-RSRP value exceeds a threshold.

FIG. 13 depicts example content of a report indicating for a strongest resource and a weakest resource whether their associated L1-RSRP value exceeds a threshold.

FIG. 14 depicts example content of a report indicating for a subset of strongest resources and a subset of weakest resources whether their associated L1-RSRP values exceeds a threshold.

FIG. 15 depicts a method for wireless communications at a UE.

FIG. 16 depicts a method for wireless communications at a network entity.

FIGS. 17 and 18 depict aspects of example communications devices.

### DETAILED DESCRIPTION

A beam prediction process may include identification of beam qualities and failures corresponding to different beams. A user equipment (UE) or a network entity may perform machine learning (ML)-based beam prediction using continuously measured or reported channel characteristic values (e.g., layer one reference signal received power (L1-RSRP) values) corresponding to the different beams.

In some cases, during the beam prediction process at the UE, the UE may not consider reporting of L1-RSRPs (e.g., measured L1-RSRPs or predicted L1-RSRPs based on a ML model) corresponding to the different beams to be useful for the beam prediction due to possible errors. For example, the measured L1-RSRPs may generally include up to ±11.5 decibel (dB) error. The predicted L1-RSRPs may include additional errors over measurement errors associated with the measured L1-RSRPs (e.g., since one of the inputs to the ML model is the measured L1-RSRPs, it may not lead to reliable or accurate values of the predicted L1-RSRPs).

In such cases, although the UE may not be confident at all about the accuracy of the measured or predicted L1-RSRPs for the different beams, however, the UE may still be more confident about the accuracy of relative differences between the predicted L1-RSRPs corresponding to the different beams or a range of the predicted L1-RSRPs (e.g., whether the predicted L1-RSRPs are above or below −100 decibel-milliwatts (dBm)). In these cases, there is a need for the UE to report the relative differences between the predicted L1-RSRPs and/or the range of the predicted L1-RSRPs since this reported information can be beneficial for the correct beam prediction and selection.

Aspects of the present disclosure provide apparatuses, methods, processing systems, and computer-readable mediums for managing and reporting L1-RSRPs corresponding to different beams. For example, techniques proposed herein may be implemented to report differential L1-RSRPs corresponding to the different beams (rather than inaccurate absolute values of L1-RSRPs corresponding to the different beams). The differential L1-RSRPs are based on a prediction-based measurement of the L1-RSRPs corresponding to the different beams rather than an actual measurement of the L1-RSRPs. The correct beams may be selected for scheduling resources, in accordance with their corresponding differential L1-RSRPs, and thereby improving system performance.

### Introduction to Wireless Communications Networks

The techniques and methods described herein may be used for various wireless communications networks. While aspects may be described herein using terminology commonly associated with 3G, 4G, and/or 5G wireless technologies, aspects of the present disclosure may likewise be applicable to other communications systems and standards not explicitly mentioned herein.

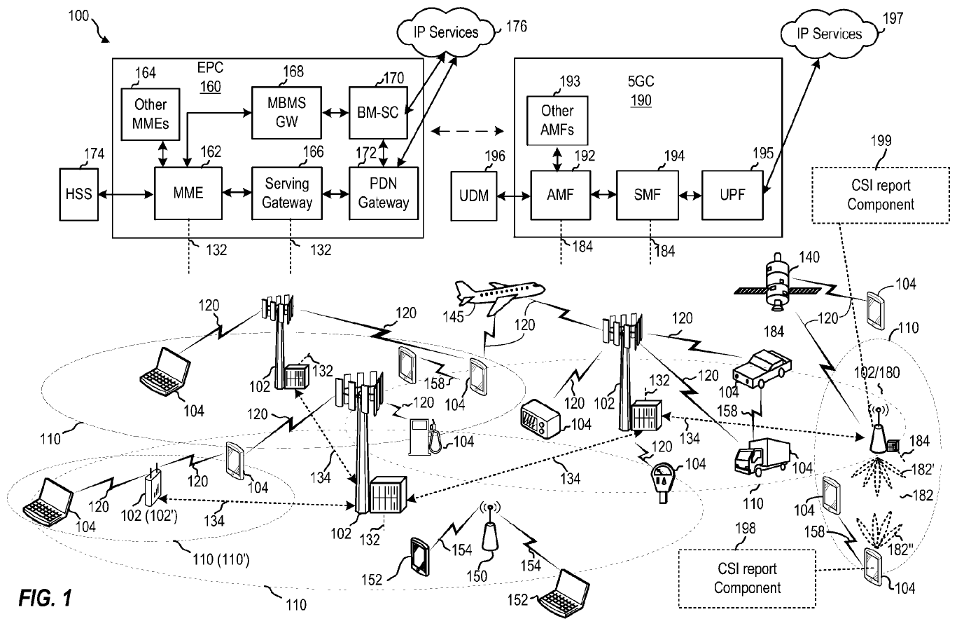

FIG. 1 depicts an example of a wireless communications network 100, in which aspects described herein may be implemented.

Generally, wireless communications network 100 includes various network entities (alternatively, network elements or network nodes). A network entity is generally a communications device and/or a communications function performed by a communications device (e.g., a user equipment (UE), a base station (BS), a component of a BS, a server, etc.). For example, various functions of a network as well as various devices associated with and interacting with a network may be considered network entities. Further, wireless communications network 100 includes terrestrial aspects, such as ground-based network entities (e.g., BSs 102), and non-terrestrial aspects, such as satellite 140 and aircraft 145, which may include network entities on-board (e.g., one or more BSs) capable of communicating with other network elements (e.g., terrestrial BSs) and UEs.

In the depicted example, wireless communications network 100 includes BSs 102, UEs 104, and one or more core networks, such as an Evolved Packet Core (EPC) 160 and 5G Core (5GC) network 190, which interoperate to provide communications services over various communications links, including wired and wireless links.

FIG. 1 depicts various example UEs 104, which may more generally include: a cellular phone, smart phone, session initiation protocol (SIP) phone, laptop, personal digital assistant (PDA), satellite radio, global positioning system, multimedia device, video device, digital audio player, camera, game console, tablet, smart device, wearable device, vehicle, electric meter, gas pump, large or small kitchen appliance, healthcare device, implant, sensor/actuator, display, internet of things (IoT) devices, always on (AON) devices, edge processing devices, or other similar devices. UEs 104 may also be referred to more generally as a mobile device, a wireless device, a wireless communications device, a station, a mobile station, a subscriber station, a mobile subscriber station, a mobile unit, a subscriber unit, a wireless unit, a remote unit, a remote device, an access terminal, a mobile terminal, a wireless terminal, a remote terminal, a handset, and others.

BSs 102 wirelessly communicate with (e.g., transmit signals to or receive signals from) UEs 104 via communications links 120. The communications links 120 between BSs 102 and UEs 104 may include uplink (UL) (also referred to as reverse link) transmissions from a UE 104 to a BS 102 and/or downlink (DL) (also referred to as forward link) transmissions from a BS 102 to a UE 104. The communications links 120 may use multiple-input and multiple-output (MIMO) antenna technology, including spatial multiplexing, beamforming, and/or transmit diversity in various aspects.

BSs 102 may generally include: a NodeB, enhanced NodeB (eNB), next generation enhanced NodeB (ng-eNB), next generation NodeB (gNB or gNodeB), access point, base transceiver station, radio BS, radio transceiver, transceiver function, transmission reception point, and/or others. Each of BSs 102 may provide communications coverage for a respective geographic coverage area 110, which may sometimes be referred to as a cell, and which may overlap in some cases (e.g., small cell 102′ may have a coverage area 110′ that overlaps the coverage area 110 of a macro cell). A BS may, for example, provide communications coverage for a macro cell (covering relatively large geographic area), a pico cell (covering relatively smaller geographic area, such as a sports stadium), a femto cell (relatively smaller geographic area (e.g., a home)), and/or other types of cells.

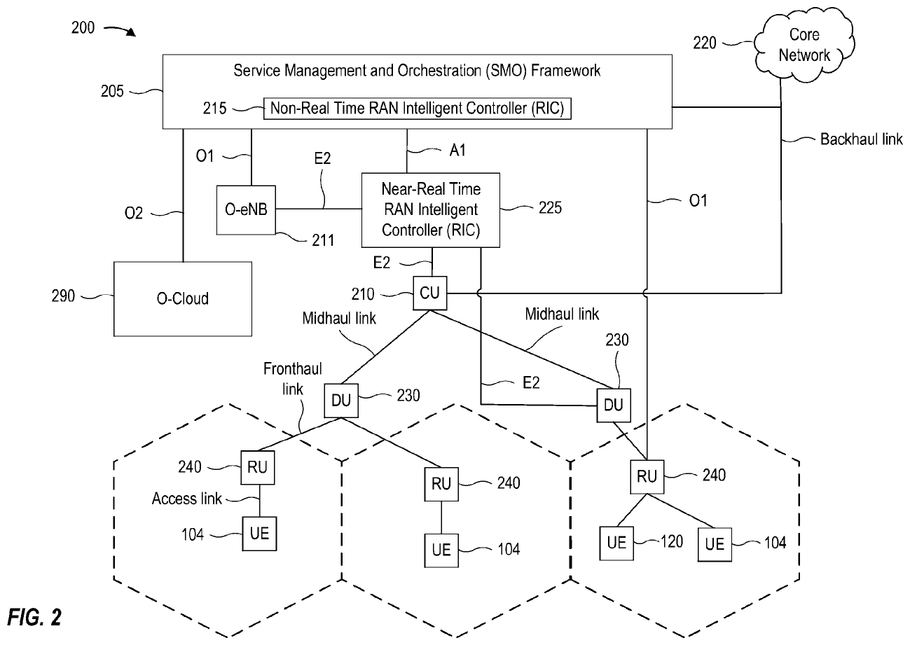

While BSs 102 are depicted in various aspects as unitary communications devices, BSs 102 may be implemented in various configurations. For example, one or more components of a BS 102 may be disaggregated, including a central unit (CU), one or more distributed units (DUs), one or more radio units (RUs), a Near-Real Time (Near-RT) RAN Intelligent Controller (RIC), or a Non-Real Time (Non-RT) RIC, to name a few examples. In another example, various aspects of a BS 102 may be virtualized. More generally, a BS (e.g., BS 102) may include components that are located at a single physical location or components located at various physical locations. In examples in which a BS 102 includes components that are located at various physical locations, the various components may each perform functions such that, collectively, the various components achieve functionality that is similar to a BS 102 that is located at a single physical location. In some aspects, a BS 102 including components that are located at various physical locations may be referred to as a disaggregated radio access network (RAN) architecture, such as an Open RAN (O-RAN) or Virtualized RAN (VRAN) architecture. FIG. 2 depicts and describes an example disaggregated BS architecture.

Different BSs 102 within wireless communications network 100 may also be configured to support different radio access technologies, such as 3G, 4G, and/or 5G. For example, BSs 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., an S1 interface). BSs 102 configured for 5G (e.g., 5G NR or Next Generation RAN (NG-RAN)) may interface with 5GC 190 through second backhaul links 184. BSs 102 may communicate directly or indirectly (e.g., through the EPC 160 or 5GC 190) with each other over third backhaul links 134 (e.g., X2 interface), which may be wired or wireless.

Wireless communications network 100 may subdivide the electromagnetic spectrum into various classes, bands, channels, or other features. In some aspects, the subdivision is provided based on wavelength and frequency, where frequency may also be referred to as a carrier, a subcarrier, a frequency channel, a tone, or a subband. For example, 3GPP currently defines Frequency Range 1 (FR1) as including 600 MHz-6 GHz, which is often referred to (interchangeably) as “Sub-6 GHz”. Similarly, 3GPP currently defines Frequency Range 2 (FR2) as including 26-41 GHz, which is sometimes referred to (interchangeably) as a “millimeter wave” (“mmW” or “mmWave”). A BS configured to communicate using mmWave/near mmWave radio frequency bands (e.g., a mmWave BS such as BS 180) may utilize beamforming (e.g., 182) with a UE (e.g., 104) to improve path loss and range.

The communications links 120 between BSs 102 and, for example, UEs 104, may be through one or more carriers, which may have different bandwidths (e.g., 5, 10, 15, 20, 100, 400, and/or other MHz), and which may be aggregated in various aspects. Carriers may or may not be adjacent to each other. Allocation of carriers may be asymmetric with respect to DL and UL (e.g., more or fewer carriers may be allocated for DL than for UL).

Communications using higher frequency bands may have higher path loss and a shorter range compared to lower frequency communications. Accordingly, certain BSs (e.g., 180 in FIG. 1) may utilize beamforming 182 with a UE 104 to improve path loss and range. For example, BS 180 and the UE 104 may each include a plurality of antennas, such as antenna elements, antenna panels, and/or antenna arrays to facilitate the beamforming. In some cases, BS 180 may transmit a beamformed signal to UE 104 in one or more transmit directions 182′. UE 104 may receive the beamformed signal from the BS 180 in one or more receive directions 182″. UE 104 may also transmit a beamformed signal to the BS 180 in one or more transmit directions 182″. BS 180 may also receive the beamformed signal from UE 104 in one or more receive directions 182′. BS 180 and UE 104 may then perform beam training to determine the best receive and transmit directions for each of BS 180 and UE 104. Notably, the transmit and receive directions for BS 180 may or may not be the same. Similarly, the transmit and receive directions for UE 104 may or may not be the same.

Wireless communications network 100 further includes a Wi-Fi AP 150 in communication with Wi-Fi stations (STAs) 152 via communications links 154 in, for example, a 2.4 GHz and/or 5 GHz unlicensed frequency spectrum.

Certain UEs 104 may communicate with each other using device-to-device (D2D) communications link 158. D2D communications link 158 may use one or more sidelink channels, such as a physical sidelink broadcast channel (PSBCH), a physical sidelink discovery channel (PSDCH), a physical sidelink shared channel (PSSCH), a physical sidelink control channel (PSCCH), and/or a physical sidelink feedback channel (PSFCH).

EPC 160 may include various functional components, including: a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and/or a Packet Data Network (PDN) Gateway 172, such as in the depicted example. MME 162 may be in communication with a Home Subscriber Server (HSS) 174. MME 162 is the control node that processes the signaling between the UEs 104 and the EPC 160. Generally, MME 162 provides bearer and connection management.

Generally, user Internet protocol (IP) packets are transferred through Serving Gateway 166, which itself is connected to PDN Gateway 172. PDN Gateway 172 provides UE IP address allocation as well as other functions. PDN Gateway 172 and the BM-SC 170 are connected to IP Services 176, which may include, for example, the Internet, an intranet, an IP Multimedia Subsystem (IMS), a Packet Switched (PS) streaming service, and/or other IP services.

BM-SC 170 may provide functions for MBMS user service provisioning and delivery. BM-SC 170 may serve as an entry point for content provider MBMS transmission, may be used to authorize and initiate MBMS Bearer Services within a public land mobile network (PLMN), and/or may be used to schedule MBMS transmissions. MBMS Gateway 168 may be used to distribute MBMS traffic to the BSs 102 belonging to a Multicast Broadcast Single Frequency Network (MBSFN) area broadcasting a particular service, and/or may be responsible for session management (start/stop) and for collecting eMBMS related charging information.

5GC 190 may include various functional components, including: an Access and Mobility Management Function (AMF) 192, other AMFs 193, a Session Management Function (SMF) 194, and a User Plane Function (UPF) 195. AMF 192 may be in communication with Unified Data Management (UDM) 196.

AMF 192 is a control node that processes signaling between UEs 104 and 5GC 190. AMF 192 provides, for example, quality of service (QoS) flow and session management.

Internet protocol (IP) packets are transferred through UPF 195, which is connected to the IP Services 197, and which provides UE IP address allocation as well as other functions for 5GC 190. IP Services 197 may include, for example, the Internet, an intranet, an IMS, a PS streaming service, and/or other IP services.

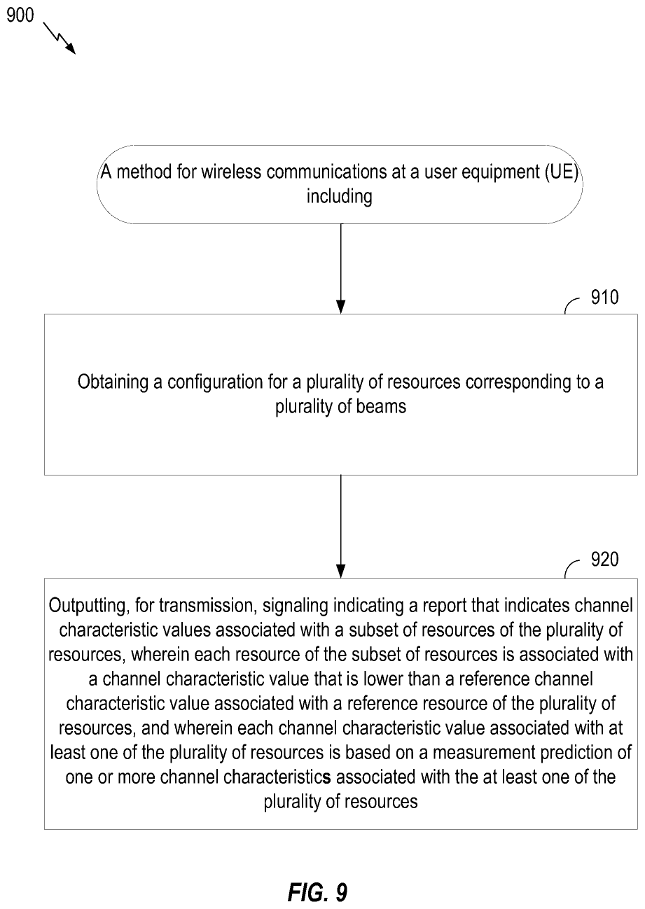

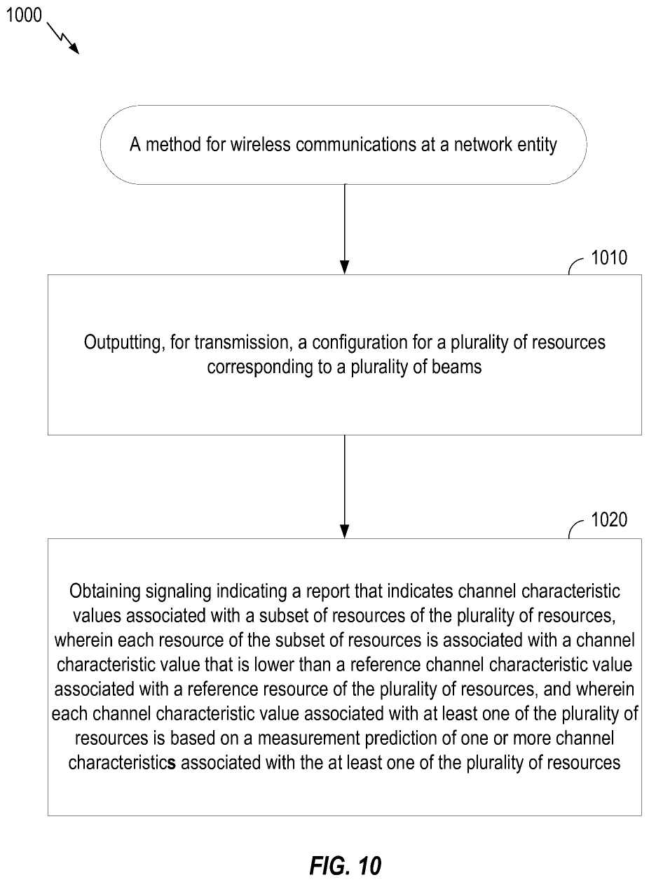

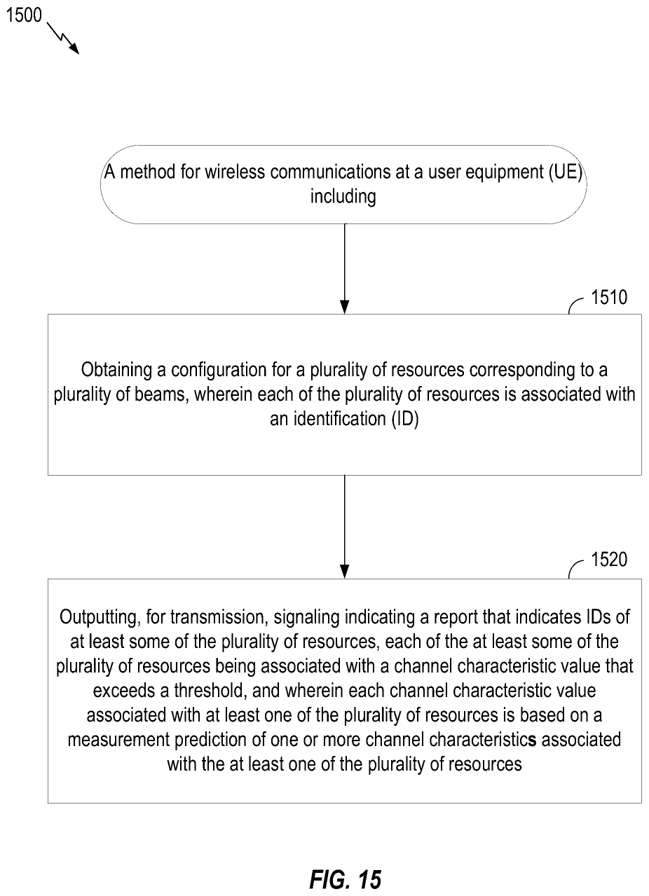

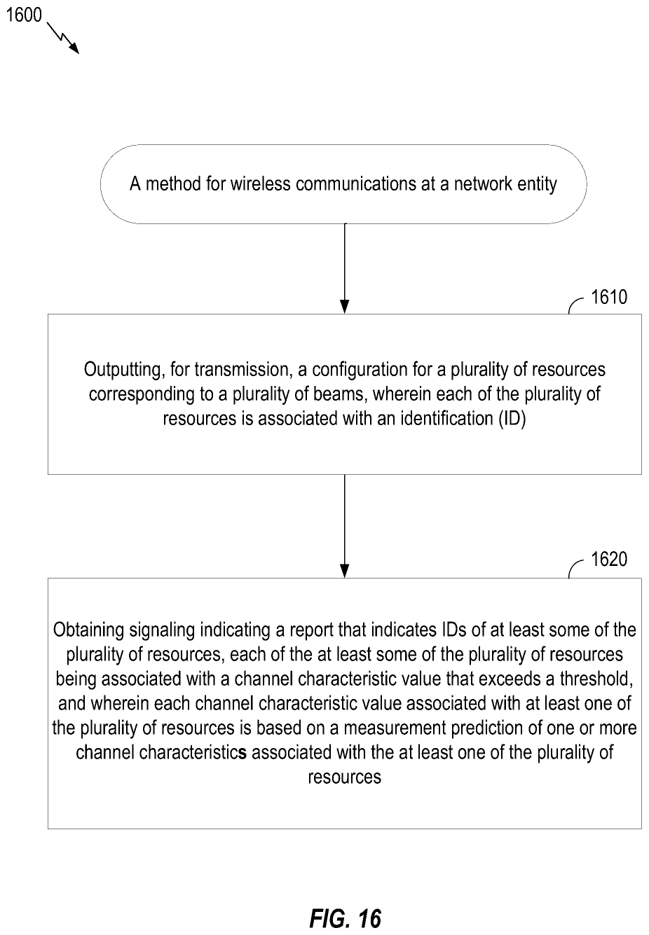

Wireless communication network 100 further includes channel state information (CSI) report component 198, which may be configured to perform method 900 of FIG. 9 and/or method 1500 of FIG. 15. Wireless communication network 100 further includes CSI report component 199, which may be configured to perform method 1000 of FIG. 10 and/or method 1600 of FIG. 16.

In various aspects, a network entity or network node can be implemented as an aggregated BS, as a disaggregated BS, a component of a BS, an integrated access and backhaul (IAB) node, a relay node, a sidelink node, to name a few examples.

FIG. 2 depicts an example disaggregated BS 200 architecture. The disaggregated BS 200 architecture may include one or more central units (CUs) 210 that can communicate directly with a core network 220 via a backhaul link, or indirectly with the core network 220 through one or more disaggregated BS units (such as a Near-Real Time (Near-RT) RAN Intelligent Controller (RIC) 225 via an E2 link, or a Non-Real Time (Non-RT) RIC 215 associated with a Service Management and Orchestration (SMO) Framework 205, or both). A CU 210 may communicate with one or more distributed units (DUs) 230 via respective midhaul links, such as an F1 interface. The DUs 230 may communicate with one or more radio units (RUs) 240 via respective fronthaul links. The RUs 240 may communicate with respective UEs 104 via one or more radio frequency (RF) access links. In some implementations, the UE 104 may be simultaneously served by multiple RUs 240.

Each of the units, e.g., the CUs 210, the DUs 230, the RUs 240, as well as the Near-RT RICs 225, the Non-RT RICs 215 and the SMO Framework 205, may include one or more interfaces or be coupled to one or more interfaces configured to receive or transmit signals, data, or information (collectively, signals) via a wired or wireless transmission medium. Each of the units, or an associated processor or controller providing instructions to the communications interfaces of the units, can be configured to communicate with one or more of the other units via the transmission medium. For example, the units can include a wired interface configured to receive or transmit signals over a wired transmission medium to one or more of the other units. Additionally or alternatively, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 210 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 210. The CU 210 may be configured to handle user plane functionality (e.g., Central Unit—User Plane (CU-UP)), control plane functionality (e.g., Central Unit—Control Plane (CU-CP)), or a combination thereof. In some implementations, the CU 210 can be logically split into one or more CU-UP units and one or more CU-CP units. The CU-UP unit can communicate bidirectionally with the CU-CP unit via an interface, such as the E1 interface when implemented in an O-RAN configuration. The CU 210 can be implemented to communicate with the DU 230, as necessary, for network control and signaling.

The DU 230 may correspond to a logical unit that includes one or more BS functions to control the operation of one or more RUs 240. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3^{rd} Generation Partnership Project (3GPP). In some aspects, the DU 230 may further host one or more low PHY layers. Each layer (or module) can be implemented with an interface configured to communicate signals with other layers (and modules) hosted by the DU 230, or with the control functions hosted by the CU 210.

Lower-layer functionality can be implemented by one or more RUs 240. In some deployments, an RU 240, controlled by a DU 230, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 240 can be implemented to handle over the air (OTA) communications with one or more UEs 104. In some implementations, real-time and non-real-time aspects of control and user plane communications with the RU(s) 240 can be controlled by the corresponding DU 230. In some scenarios, this configuration can enable the DU(s) 230 and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements which may be managed via an operations and maintenance interface (such as an O1 interface). For virtualized network elements, the SMO Framework 205 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements can include, but are not limited to, CUs 210, DUs 230, RUs 240 and Near-RT RICs 225. In some implementations, the SMO Framework 205 can communicate with a hardware aspect of a 4G RAN, such as an open eNB (O-eNB) 211, via an O1 interface. Additionally, in some implementations, the SMO Framework 205 can communicate directly with one or more RUs 240 via an O1 interface. The SMO Framework 205 also may include a Non-RT RIC 215 configured to support functionality of the SMO Framework 205.

The Non-RT RIC 215 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 225. The Non-RT RIC 215 may be coupled to or communicate with (such as via an A1 interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs 210, one or more DUs 230, or both, as well as an O-eNB, with the Near-RT RIC 225.

In some implementations, to generate AI/ML models to be deployed in the Near-RT RIC 225, the Non-RT RIC 215 may receive parameters or external enrichment information from external servers. Such information may be utilized by the Near-RT RIC 225 and may be received at the SMO Framework 205 or the Non-RT RIC 215 from non-network data sources or from network functions. In some examples, the Non-RT RIC 215 or the Near-RT RIC 225 may be configured to tune RAN behavior or performance. For example, the Non-RT RIC 215 may monitor long-term trends and patterns for performance and employ AI/ML models to perform corrective actions through the SMO Framework 205 (such as reconfiguration via O1) or via creation of RAN management policies (such as A1 policies).

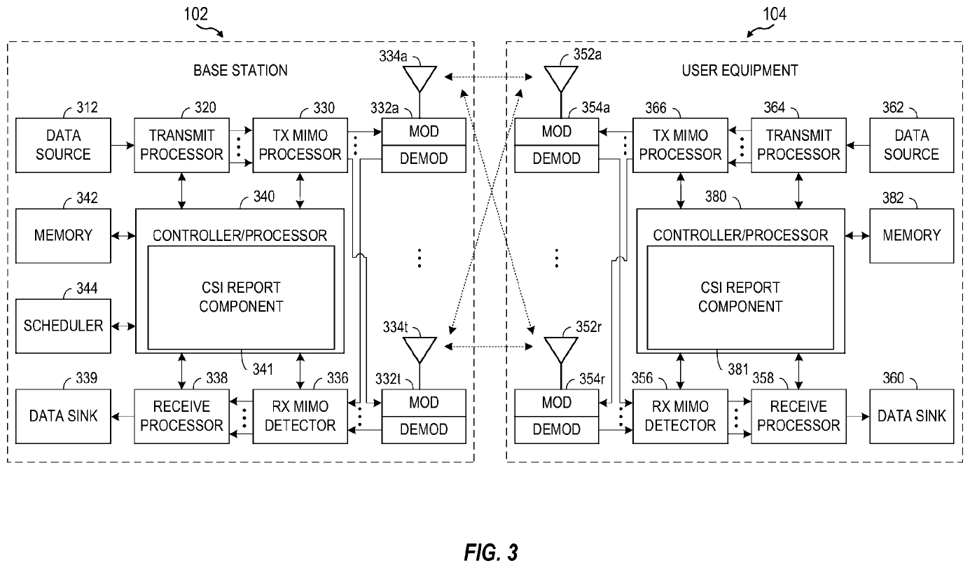

FIG. 3 depicts aspects of an example BS 102 and a UE 104.

Generally, BS 102 includes various processors (e.g., 320, 330, 338, and 340), antennas 334a-t (collectively 334), transceivers 332a-t (collectively 332), which include modulators and demodulators, and other aspects, which enable wireless transmission of data (e.g., data source 312) and wireless reception of data (e.g., data sink 339). For example, BS 102 may send and receive data between BS 102 and UE 104. BS 102 includes controller/processor 340, which may be configured to implement various functions described herein related to wireless communications.

BS 102 includes controller/processor 340, which may be configured to implement various functions related to wireless communications. In the depicted example, controller/processor 340 includes CSI report component 341, which may be representative of CSI report component 199 of FIG. 1. Notably, while depicted as an aspect of controller/processor 340, CSI report component 341 may be implemented additionally or alternatively in various other aspects of BS 102 in other implementations.

Generally, UE 104 includes various processors (e.g., 358, 364, 366, and 380), antennas 352a-r (collectively 352), transceivers 354a-r (collectively 354), which include modulators and demodulators, and other aspects, which enable wireless transmission of data (e.g., retrieved from data source 362) and wireless reception of data (e.g., provided to data sink 360). UE 104 includes controller/processor 380, which may be configured to implement various functions described herein related to wireless communications.

UE 104 includes controller/processor 380, which may be configured to implement various functions related to wireless communications. In the depicted example, controller/processor 380 includes CSI report component 381, which may be representative of CSI report component 198 of FIG. 1. Notably, while depicted as an aspect of controller/processor 380, CSI report component 381 may be implemented additionally or alternatively in various other aspects of UE 104 in other implementations.

In regards to an example downlink transmission, BS 102 includes a transmit processor 320 that may receive data from a data source 312 and control information from a controller/processor 340. The control information may be for the physical broadcast channel (PBCH), physical control format indicator channel (PCFICH), physical HARQ indicator channel (PHICH), physical downlink control channel (PDCCH), group common PDCCH (GC PDCCH), and/or others. The data may be for the physical downlink shared channel (PDSCH), in some examples.

Transmit processor 320 may process (e.g., encode and symbol map) the data and control information to obtain data symbols and control symbols, respectively. Transmit processor 320 may also generate reference symbols, such as for the primary synchronization signal (PSS), secondary synchronization signal (SSS), PBCH demodulation reference signal (DMRS), and channel state information reference signal (CSI-RS).

Transmit (TX) multiple-input multiple-output (MIMO) processor 330 may perform spatial processing (e.g., precoding) on the data symbols, the control symbols, and/or the reference symbols, if applicable, and may provide output symbol streams to the modulators (MODs) in transceivers 332a-332t. Each modulator in transceivers 332a-332t may process a respective output symbol stream to obtain an output sample stream. Each modulator may further process (e.g., convert to analog, amplify, filter, and upconvert) the output sample stream to obtain a downlink signal. Downlink signals from the modulators in transceivers 332a-332t may be transmitted via the antennas 334a-334t, respectively.

In order to receive the downlink transmission, UE 104 includes antennas 352a-352r that may receive the downlink signals from the BS 102 and may provide received signals to the demodulators (DEMODs) in transceivers 354a-354r, respectively. Each demodulator in transceivers 354a-354r may condition (e.g., filter, amplify, downconvert, and digitize) a respective received signal to obtain input samples. Each demodulator may further process the input samples to obtain received symbols.

MIMO detector 356 may obtain received symbols from all the demodulators in transceivers 354a-354r, perform MIMO detection on the received symbols if applicable, and provide detected symbols. Receive processor 358 may process (e.g., demodulate, deinterleave, and decode) the detected symbols, provide decoded data for the UE 104 to a data sink 360, and provide decoded control information to a controller/processor 380.

In regards to an example uplink transmission, UE 104 further includes a transmit processor 364 that may receive and process data (e.g., for the PUSCH) from a data source 362 and control information (e.g., for the physical uplink control channel (PUCCH)) from the controller/processor 380. Transmit processor 364 may also generate reference symbols for a reference signal (e.g., for the sounding reference signal (SRS)). The symbols from the transmit processor 364 may be precoded by a TX MIMO processor 366 if applicable, further processed by the modulators in transceivers 354a-354r (e.g., for SC-FDM), and transmitted to BS 102.

At BS 102, the uplink signals from UE 104 may be received by antennas 334a-t, processed by the demodulators in transceivers 332a-332t, detected by a MIMO detector 336 if applicable, and further processed by a receive processor 338 to obtain decoded data and control information sent by UE 104. Receive processor 338 may provide the decoded data to a data sink 339 and the decoded control information to the controller/processor 340.

Memories 342 and 382 may store data and program codes for BS 102 and UE 104, respectively.

Scheduler 344 may schedule UEs for data transmission on the downlink and/or uplink.

In various aspects, BS 102 may be described as transmitting and receiving various types of data associated with the methods described herein. In these contexts, “transmitting” may refer to various mechanisms of outputting data, such as outputting data from data source 312, scheduler 344, memory 342, transmit processor 320, controller/processor 340, TX MIMO processor 330, transceivers 332a-t, antenna 334a-t, and/or other aspects described herein. Similarly, “receiving” may refer to various mechanisms of obtaining data, such as obtaining data from antennas 334a-t, transceivers 332a-t, RX MIMO detector 336, controller/processor 340, receive processor 338, scheduler 344, memory 342, and/or other aspects described herein.

In various aspects, UE 104 may likewise be described as transmitting and receiving various types of data associated with the methods described herein. In these contexts, “transmitting” may refer to various mechanisms of outputting data, such as outputting data from data source 362, memory 382, transmit processor 364, controller/processor 380, TX MIMO processor 366, transceivers 354a-t, antenna 352a-t, and/or other aspects described herein. Similarly, “receiving” may refer to various mechanisms of obtaining data, such as obtaining data from antennas 352a-t, transceivers 354a-t, RX MIMO detector 356, controller/processor 380, receive processor 358, memory 382, and/or other aspects described herein.

In some aspects, a processor may be configured to perform various operations, such as those associated with the methods described herein, and transmit (output) to or receive (obtain) data from another interface that is configured to transmit or receive, respectively, the data.

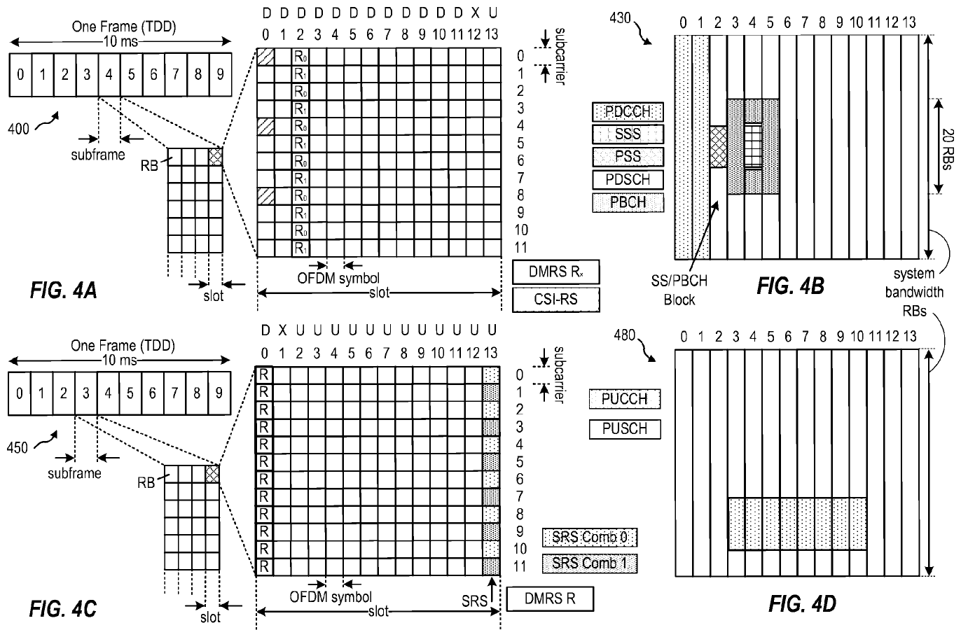

FIGS. 4A, 4B, 4C, and 4D depict aspects of data structures for a wireless communications network, such as wireless communications network 100 of FIG. 1.

In particular, FIG. 4A is a diagram 400 illustrating an example of a first subframe within a 5G (e.g., 5G NR) frame structure, FIG. 4B is a diagram 430 illustrating an example of DL channels within a 5G subframe, FIG. 4C is a diagram 450 illustrating an example of a second subframe within a 5G frame structure, and FIG. 4D is a diagram 480 illustrating an example of UL channels within a 5G subframe.

Wireless communications systems may utilize orthogonal frequency division multiplexing (OFDM) with a cyclic prefix (CP) on the uplink and downlink. Such systems may also support half-duplex operation using time division duplexing (TDD). OFDM and single-carrier frequency division multiplexing (SC-FDM) partition the system bandwidth (e.g., as depicted in FIGS. 4B and 4D) into multiple orthogonal subcarriers. Each subcarrier may be modulated with data. Modulation symbols may be sent in the frequency domain with OFDM and/or in the time domain with SC-FDM.

A wireless communications frame structure may be frequency division duplex (FDD), in which, for a particular set of subcarriers, subframes within the set of subcarriers are dedicated for either DL or UL. Wireless communications frame structures may also be time division duplex (TDD), in which, for a particular set of subcarriers, subframes within the set of subcarriers are dedicated for both DL and UL.

In FIGS. 4A and 4C, the wireless communications frame structure is TDD where D is DL, U is UL, and X is flexible for use between DL/UL. UEs may be configured with a slot format through a received slot format indicator (SFI) (dynamically through DL control information (DCI), or semi-statically/statically through radio resource control (RRC) signaling). In the depicted examples, a 10 ms frame is divided into 10 equally sized 1 ms subframes. Each subframe may include one or more time slots. In some examples, each slot may include 7 or 14 symbols, depending on the slot format. Subframes may also include mini-slots, which generally have fewer symbols than an entire slot. Other wireless communications technologies may have a different frame structure and/or different channels.

In certain aspects, the number of slots within a subframe is based on a slot configuration and a numerology. For example, for slot configuration 0, different numerologies (μ) 0 to 5 allow for 1, 2, 4, 8, 16, and 32 slots, respectively, per subframe. For slot configuration 1, different numerologies 0 to 2 allow for 2, 4, and 8 slots, respectively, per subframe. Accordingly, for slot configuration 0 and numerology g, there are 14 symbols/slot and 2μ slots/subframe. The subcarrier spacing and symbol length/duration are a function of the numerology. The subcarrier spacing may be equal to 2^{μ}×15 kHz, where g is the numerology 0 to 5. As such, the numerology μ=0 has a subcarrier spacing of 15 kHz and the numerology μ=5 has a subcarrier spacing of 480 kHz. The symbol length/duration is inversely related to the subcarrier spacing. FIGS. 4A, 4B, 4C, and 4D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 μs.

As depicted in FIGS. 4A, 4B, 4C, and 4D, a resource grid may be used to represent the frame structure. Each time slot includes a resource block (RB) (also referred to as physical RBs (PRBs)) that extends, for example, 12 consecutive subcarriers. The resource grid is divided into multiple resource elements (REs). The number of bits carried by each RE depends on the modulation scheme.

As illustrated in FIG. 4A, some of the REs carry reference (pilot) signals (RS) for a UE (e.g., UE 104 of FIGS. 1 and 3). The RS may include demodulation RS (DMRS) and/or channel state information reference signals (CSI-RS) for channel estimation at the UE. The RS may also include beam measurement RS (BRS), beam refinement RS (BRRS), and/or phase tracking RS (PT-RS).

FIG. 4B illustrates an example of various DL channels within a subframe of a frame. The physical downlink control channel (PDCCH) carries DCI within one or more control channel elements (CCEs), each CCE including, for example, nine RE groups (REGs), each REG including, for example, four consecutive REs in an OFDM symbol.

A primary synchronization signal (PSS) may be within symbol 2 of particular subframes of a frame. The PSS is used by a UE (e.g., 104 of FIGS. 1 and 3) to determine subframe/symbol timing and a physical layer identity.

A secondary synchronization signal (SSS) may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the aforementioned DMRS. The physical broadcast channel (PBCH), which carries a master information block (MIB), may be logically grouped with the PSS and SSS to form a synchronization signal (SS)/PBCH block. The MIB provides a number of RBs in the system bandwidth and a system frame number (SFN). The physical downlink shared channel (PDSCH) carries user data, broadcast system information not transmitted through the PBCH such as system information blocks (SIBs), and/or paging messages.

As illustrated in FIG. 4C, some of the REs carry DMRS (indicated as R for one particular configuration, but other DMRS configurations are possible) for channel estimation at the BS. The UE may transmit DMRS for the PUCCH and DMRS for the PUSCH. The PUSCH DMRS may be transmitted, for example, in the first one or two symbols of the PUSCH. The PUCCH DMRS may be transmitted in different configurations depending on whether short or long PUCCHs are transmitted and depending on the particular PUCCH format used. UE 104 may transmit sounding reference signals (SRS). The SRS may be transmitted, for example, in the last symbol of a subframe. The SRS may have a comb structure, and a UE may transmit SRS on one of the combs. The SRS may be used by a BS for channel quality estimation to enable frequency-dependent scheduling on the UL.

FIG. 4D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

### Introduction to mmWave Wireless Communications

In wireless communications, an electromagnetic spectrum is often subdivided into various classes, bands, channels, or other features. The subdivision is often provided based on wavelength and frequency, where frequency may also be referred to as a carrier, a subcarrier, a frequency channel, a tone, or a subband.

5^{th} generation (5G) networks may utilize several frequency ranges, which in some cases are defined by a standard, such as 3rd generation partnership project (3GPP) standards. For example, 3GPP technical standard TS 38.101 currently defines Frequency Range 1 (FR1) as including 600 MHz-6 GHz, though specific uplink and downlink allocations may fall outside of this general range. Thus, FR1 is often referred to (interchangeably) as a “Sub-6 GHz” band.

Similarly, TS 38.101 currently defines Frequency Range 2 (FR2) as including 26-41 GHz, though again specific uplink and downlink allocations may fall outside of this general range. FR2, is sometimes referred to (interchangeably) as a “millimeter wave” (“mmW” or “mmWave”) band, despite being different from the extremely high frequency (EHF) band (30 GHz-300 GHz) that is identified by the International Telecommunications Union (ITU) as a “millimeter wave” band because wavelengths at these frequencies are between 1 millimeter and 10 millimeters.

Communications using mmWave/near mmWave radio frequency band (e.g., 3 GHz-300 GHz) may have higher path loss and a shorter range compared to lower frequency communications. As described above with respect to FIG. 1, a base station (BS) (e.g., 180) configured to communicate using mmWave/near mmWave radio frequency bands may utilize beamforming (e.g., 182) with a user equipment (UE) (e.g., 104) to improve path loss and range.

### Overview of Beam Refinement Procedures

In millimeter wave (mmW) systems, beamforming is necessary to overcome high path-losses. The beamforming refers to establishing a link between a network entity and a user equipment (UE), where both these devices form a beam corresponding to each other. For example, both the network entity and the UE find at least one adequate beam to form a communication link between each other. Network entity-beam and UE-beam form what is known as a beam pair link (BPL). As an example, on a downlink (DL), the network entity uses a transmit beam and the UE uses a receive beam corresponding to the transmit beam to receive a downlink transmission. The combination of the transmit beam and the corresponding receive beam is the BPL.

As a part of a beam management process, beams used by the network entity and the UE have to be refined periodically because of changing channel conditions and movement of the UE or other objects. Additionally, the performance of the BPL may be subject to fading due to Doppler spread. Thus, because of the changing channel conditions over time, the BPL has to be periodically updated or refined. Accordingly, it may be beneficial if the network entity and the UE monitor new beams and form new BPLs.

Initially, at least one BPL has to be established between the network entity and the UE for network access. However, as noted above, new BPLs may need to be discovered later between the network entity and the UE for different purposes. In some cases, the network entity may decide to use different BPLs for different channels, or for communicating with different network entities or as fallback BPLs in case an existing BPL fails. In some cases, the UE may monitor a quality of a current BPL established between the network entity and the UE, and the network entity may occasionally refine the BPL.

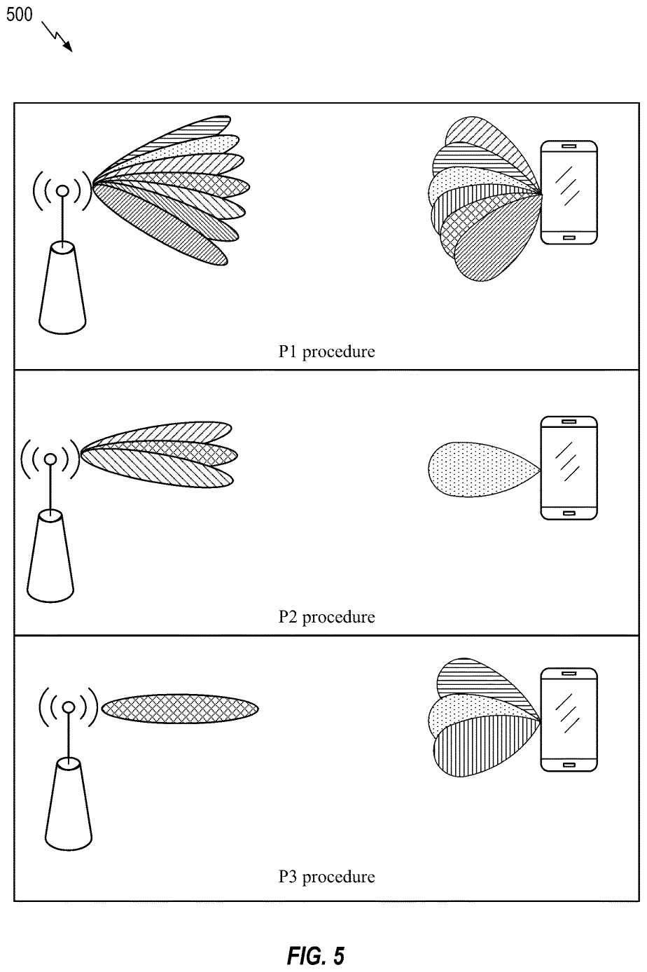

FIG. 5 depicts example beam refinement procedures 500 such as P1, P2, and P3 procedures. As depicted, the P1, the P2, and the P3 procedures are used for BPL discovery and refinement. The network entity uses the P1 procedure to enable the discovery of new BPLs. In the P1 procedure, the network entity transmits different symbols of a reference signal (RS), each beam formed in a different spatial direction such that several (most, all) relevant places of a cell are reached. Stated otherwise, the network entity transmits symbols using different transmit beams over time in different directions.

For successful reception of at least a symbol of this “P1-signal”, the UE has to find an appropriate receive beam. The UE searches using available receive beams and applying a different UE-beam during each occurrence of the periodic P1-signal.

Once the UE has succeeded in receiving a symbol of the P1-signal, the UE has discovered a BPL. The UE may not want to wait until the UE has found the best receive beam, since this may delay further actions. The UE may measure a reference signal receive power (RSRP) and report a symbol index together with the RSRP to the network entity. Such a report will contain the findings of one or more BPLs.

In an example, the UE may determine a received signal having a high RSRP. The UE may not know which beam the network entity used to transmit; however, the UE may report to the network entity the time at which the UE observed the signal having the high RSRP. The network entity may receive this report from the UE and is able to determine which network entity-beam the network entity used at the given time indicated in the report.

The network entity may offer the P2 and the P3 procedures to refine an individual BPL. The P2 procedure refines the network entity-beam of the BPL. The network entity transmits a few symbols of the RS with the different network entity-beams that are spatially close to the network entity-beam of the BPL (e.g., the network entity performs a sweep using neighboring beams around the selected beam). In the P2 procedure, the UE keeps its beam constant. Accordingly, while the UE uses the same beam as in the BPL (e.g., as illustrated in the P2 procedure in FIG. 5), the network entity-beams used for the P2 procedure are different from those for the P1 procedure in that the network entity-beams used for the P2 procedure are spaced closer together or may be more focused. The UE measures the RSRP for the various network entity-beams and indicate the best network entity-beam to the network entity.

The P3 procedure refines the UE-beam of the BPL. While the network entity-beam stays constant, the UE scans using different receive beams (e.g., the UE performs the sweep using neighboring beams). The UE measures the RSRP of each beam and identify the best UE-beam based on their associated RSRP value. Subsequently, the UE uses the best UE-beam for the BPL and report its associated RSRP to the network entity.

Overtime, the network entity and the UE establish several BPLs. When the network entity transmits a certain channel or signal, the network entity lets the UE know which BPL will be involved, so that the UE is able to tune in the direction of the correct UE receive beam before the signal starts. In this manner, every sample of the signal or channel is received by the UE using the correct receive beam. In an example, the network entity may indicate for a scheduled signal (e.g., sounding reference signal (SRS), a channel state information—reference signal (CSI-RS) or a channel (e.g., a physical downlink shared channel (PDSCH), a physical downlink control channel (PDCCH), a physical uplink shared channel (PUSCH), a physical uplink control channel (PUCCH)) which BPL is involved. In new radio (NR), this information is called quasi colocation (QCL) indication.

Two antenna ports are QCL if properties of the channel over which a symbol on one antenna port is conveyed is inferred from the channel over which a symbol on the other antenna port is conveyed. QCL supports, at least, beam management functionality, frequency/timing offset estimation functionality, and radio resource management (RRM) management functionality.

In some cases, the network entity may use the BPL which the UE has received in the past. The transmit beam for a signal to be transmitted and a previously-received signal both point in a same direction or are QCL. The QCL indication may be needed by the UE (e.g., in advance of the signal to be received) so that the UE may use a correct receive beam for each signal or channel. Some QCL indications are needed periodically when the BPL for a signal or channel changes, and some other QCL indications are needed for each scheduled instance. The QCL indication is transmitted in downlink control information (DCI), which is part of the PDCCH channel. Because the DCI is needed to control QCL information, it is desirable that a number of bits needed to indicate the QCL is not too big. In some cases, the QCL may be transmitted via a medium access control-control element (MAC-CE) or a radio resource control (RRC) message.

According to one example, whenever the UE reports a network entity-beam that the UE has received with a sufficient RSRP, and the network entity decides to use this BPL in the future, the network entity assigns a BPL tag to the network entity-beam. Accordingly, two BPLs having different network entity-beams are associated with different BPL tags. BPLs that are based on the same network entity-beams are associated with a same BPL tag. Therefore, according to this example, the BPL tag is a function of the network entity-beam of the BPL.

The wireless systems, such as mmW systems, bring gigabit speeds to cellular networks, due to availability of large amounts of bandwidth. However, the unique challenges of a heavy path-loss faced by such wireless systems necessitate new techniques such as hybrid beamforming (e.g., analog and digital), which are not present in 3^{rd} generation (3G) and 4G systems. Hybrid beamforming may enhance link budget/signal to noise ratio (SNR) that may be exploited during a random access channel (RACH) procedure. In such systems, a node B (NB) and the UE may communicate over active beam-formed transmission beams. Active beams may be considered paired transmission (Tx) and reception (Rx) beams between the NB and the UE that carry data and control channels such as the PDSCH, the PDCCH, the PUSCH, and the PUCCH. As noted above, a transmit beam used by the NB and a corresponding receive beam used by the UE for DL transmissions may be referred to as the BPL. Similarly, a transmit beam used by the UE and a corresponding receive beam used by the NB for uplink (UL) transmissions may also be referred to as the BPL.

### Overview of Beam Management Procedures

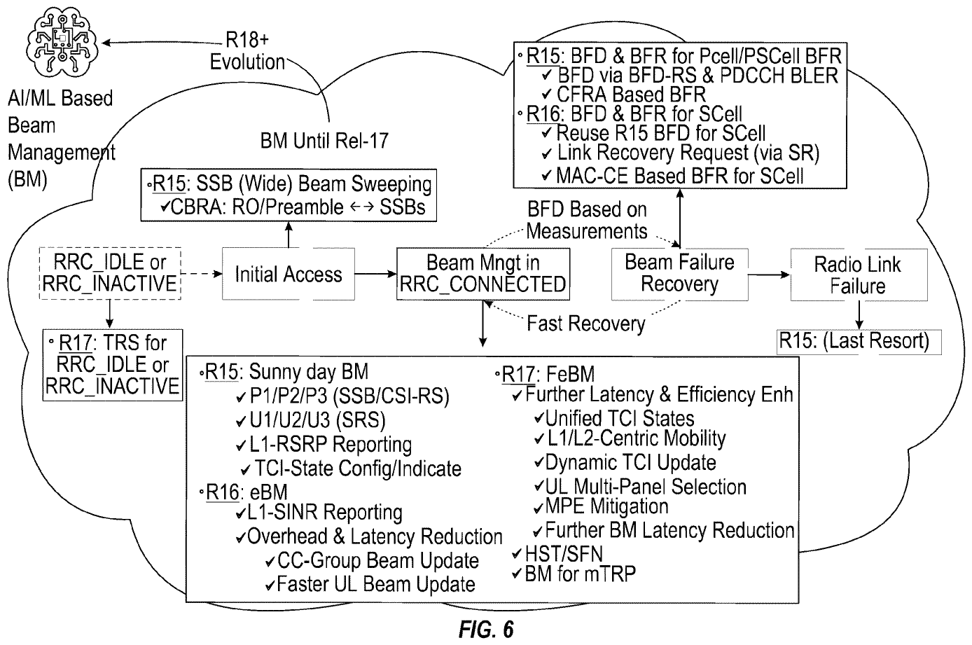

In wireless communications, various procedures may be performed for beam management. FIG. 6 is a diagram showing example operations where beam management is performed.

In initial access, a network entity sweeps through several beams (e.g., via synchronization signal blocks (SSBs)). The network entity configures a user equipment (UE) with random access channel (RACH) resources associated with beamformed SSBs to facilitate the initial access via the RACH resources. In some cases, an SSB may have a wider beam shape compared to other reference signals (RSs) such as a channel state information—reference signals (CSI-RSs). The UE may use SSB detection to identify a RACH occasion (RO) for sending a RACH preamble (e.g., as part of a contention-based random access (CBRA) procedure).

In connected mode (e.g., radio resource control (RRC) connected mode), the network entity and the UE may perform hierarchical beam refinement including beam selection (e.g., a process referred to as P1 procedure shown in FIG. 5), beam refinement for a transmitter (e.g., a process referred to as P2 procedure shown in FIG. 5), and beam refinement for a receiver (e.g., a process referred to as P3 procedure shown in FIG. 5). In beam selection (P1 procedure), the network entity sweeps through beams, and the UE reports a beam associated with best channel properties. In beam refinement for the transmitter (P2 procedure), the network entity sweeps through narrower beams, and the UE reports a beam associated with the best channel properties among the narrow beams. In beam refinement for the receiver (P3 procedure), the network entity transmits using a same beam repeatedly, and the UE refines spatial reception parameters (e.g., a spatial filter) for receiving signals from the network entity via the beam. The network entity and the UE may also perform complementary procedures (e.g., U1, U2, and U3 procedures) for uplink beam management.

In some cases where a beam failure occurs (e.g., due to beam misalignment and/or blockage), the UE performs a beam failure recovery (BFR) procedure, which allows the UE to return to the connected mode without performing a radio link failure (RLF) procedure. For example, the UE is configured with candidate beams for the BFR. In response to detecting the beam failure, the UE requests the network entity to perform the BFR via one of the candidate beams (e.g., one of the candidate beams with a reference signal received power (RSRP) above a certain threshold). In certain cases where the RLF occurs, the UE performs the RLF procedure to recover from the RLF, such as a RACH procedure.

### Overview of Beam Prediction Procedures

A user equipment (UE) or a network entity may perform machine learning (ML)-based beam prediction using continuously measured or reported channel characteristic values (such as layer one reference signal received power (L1-RSRP) values) associated with different beams in a time domain. For example, the UE or the network entity may use a pre-trained deep neural network (DNN) model for ML-based predictive beam management.

Traditionally, beam qualities and failures corresponding to the different beams are identified through measurement reports (e.g., beam strength measurement reports) carried by relevant downlink and uplink reference signals (RSs) (e.g., a synchronization signal block (SSB), a channel state information—reference signal (CSI-RS), reference signal received power (RSRP)), which may increase beam selection latency and beam management overhead, while at the same time beam selection accuracy may be limited due to restrictions on report overhead.

Instead, artificial intelligence (AI) or ML-based predictive beam management reduces an amount of RS transmissions used to predict non-measured beam qualities and future possibility of beam blockage/failure. In predictive beam management process, beam prediction is a highly non-linear problem, which is efficiently solved by the pre-trained DNN model that predicts future beam qualities, for example, based on a moving speed and trajectory of the UE that are difficult to be modeled through conventional statistical processing methods.

The AI or ML-based beam prediction may achieve predictive targets including: (1) future L1-RSRPs for currently used beams, (2) candidate selected beams with strong power in the future, and (3) possibility of failure or blockage for currently used beams.

In the predictive beam management process, the pre-trained DNN models with different targets may be implemented both in the UE and the network entity. A data collection function is used to provide training data for the network entity and/or the UE, in which the training data for the UE is collected through enhanced air interface and/or application layer approaches. The UE measures a time series of L1-RSRPs corresponding to different beams and reports the L1-RSRP measurements to the network entity as an input by the pre-trained DNN models to infer future beam activities to enable beam prediction. The inference results compared with ground truth data as training data may be used to further train the pre-trained DNN models to improve accuracy. Without repeatedly monitoring the RSs, the AI or ML-based beam prediction significantly reduces power consumption of the UE and the UE-specific RS overhead, while simultaneously improving network entity throughput and decreasing beam management latency.

In some cases, AI or ML-based spatial diversity (SD) beam prediction is used for uplink or downlink beam management. For example, the ML model deployed at the UE and/or the network entity provides explicit or implicit SD beam prediction.

In some cases, during a beam prediction process at the UE, the reporting of the L1-RSRPs (e.g., measured or predicted L1-RSRPs at the UE) corresponding to the different beams may not be useful for the beam prediction due to possible errors. For example, the measured L1-RSRPs for the different beams may include up to +11.5 decibel (dB) error. The predicted L1-RSRPs (e.g., based on AI or ML model) may include additional errors over measurement errors associated with the measured L1-RSRPs (e.g., since one of the inputs to the AI or ML model is the measured L1-RSRPs, it may not lead to reliable or accurate values of the predicted L1-RSRPs).

In some cases, the UE may determine/recommend or the network entity may control whether the predicted L1-RSRPs have to be reported (e.g., since the predicted L1-RSRPs may not be accurate values that can be used for beam prediction and selection). When the predicted L1-RSRPs are not to be reported, in some cases, the UE generates and transmits a layer 1 (L1) report that only includes beam identifications (IDs) of the different beams ordered according to their corresponding predicted L1-RSRPs.

In some cases, although the UE may not be confident at all about the accuracy of the measured or predicted L1-RSRPs for the different beams, however, the UE may be more confident about the accuracy of relative L1-RSRP differences between the predicted L1-RSRPs corresponding to the different beams or a range of the predicted L1-RSRPs (e.g., whether the predicted L1-RSRPs are above or below −100 decibel-milliwatts (dBm)). In such cases, there is a need for the UE to report the relative L1-RSRP differences between the predicted L1-RSRPs corresponding to the different beams and/or the range of the predicted L1-RSRPs, since the reported information is beneficial for the beam prediction and selection.

For example, the UE may determine that a predicted second L1-RSRP for a second strongest beam is more than 10 dB lower than a predicted first L1-RSRP for a first strongest beam. The network entity without receiving this relative predicted RSRP difference information between the different beams may schedule a physical downlink shared channel (PDSCH) for the UE using the second strongest beam rather than the first strongest beam, and this may lead to unstable outer-loop for a link adaptation (e.g., the first strongest beam may be less-preferred by the network entity due to an inter-cell interference). Therefore, it may be beneficial for the network entity to receive the relative predicted RSRP difference information between the different beams from the UE in order to select a right beam for scheduling the PDSCH.

In another example, if the UE may determine that all beams are associated with low values of predicted L1-RSRPs (e.g., below −110 dBm but with a high confidence level), it is more likely that a beam-blockage may happen and further scheduling of the PDSCH by the network entity without a large transport block (TB) size as before using one of the beams may be less reasonable or resource wasteful. Therefore, it may be beneficial for the network entity to receive the determined information from the UE in order to take a right scheduling decision.

Accordingly, although the reported L1-RSRPs (e.g., the measured or predicted L1-RSRPs that may have errors) corresponding to the different beams may be less reliable for the beam prediction and selection, however, reporting of the relative predicted RSRP difference information corresponding to the different beams or whether/how-much the predicted L1-RSRPs are beyond a network defined threshold may be more useful for the beam prediction and selection.

### Aspects Related to Differential Channel Characteristic Value Prediction Report without Absolute Channel Characteristic Value for UE-Side Beam Prediction

Aspects of the present disclosure provide apparatuses, methods, processing systems, and computer-readable mediums for managing and reporting channel characteristic values corresponding to different resources corresponding to different beams.

For example, techniques proposed herein may be implemented to report differential channel characteristic values corresponding to the different resources (rather than inaccurate absolute channel characteristic values corresponding to the different resources). The differential channel characteristic values are based on a prediction-based measurement of the channel characteristic values corresponding to the different resources rather than an actual measurement of the channel characteristic values. The resources may be selected for scheduling in accordance with their corresponding differential channel characteristic values.

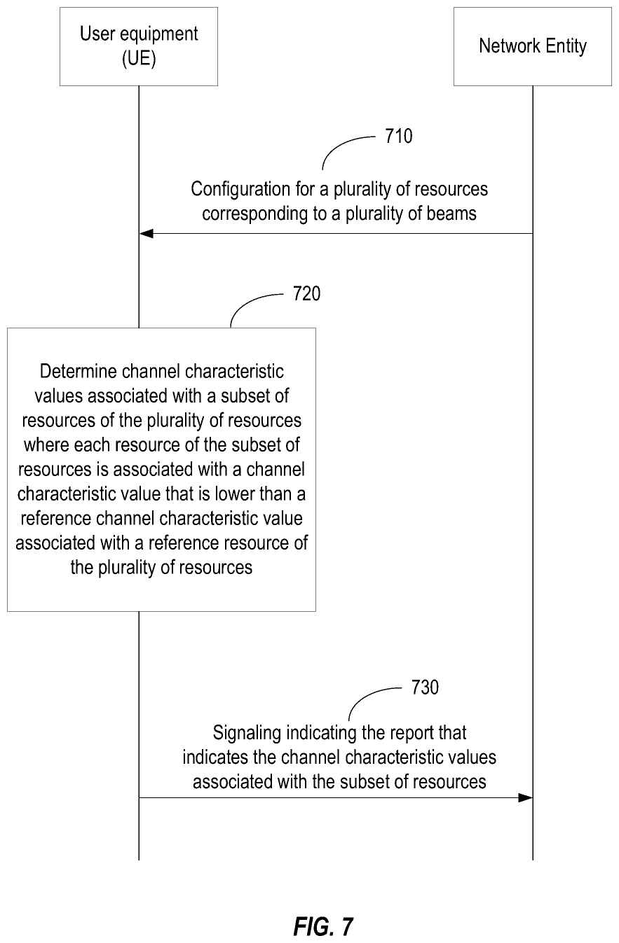

The techniques proposed herein may be understood with reference to FIGS. 7-16.

FIG. 7 depicts a call flow diagram illustrating example communication among a UE (e.g., such as UE 104 in wireless communication network 100 of FIG. 1) and a network entity (e.g., such as gNodeB (gNB)/base station (BS) 102 in wireless communication network 100 of FIG. 1).

At 710, the network entity transmits a configuration for a plurality of resources (e.g., for channel characteristics prediction) corresponding to a plurality of beams. The UE receives the configuration from the network entity. In one example, the plurality of resources may include a plurality of synchronization signal block (SSB) resources. In another example, the plurality of resources may include a plurality of CSI reference signal (CSI-RS) resources.

At 720, the UE determines a channel characteristic value associated with each resource of the plurality of resources based on a measurement prediction (e.g., via a machine learning (ML) model rather than an actual measurement) of one or more channel characteristics associated with each resource of the plurality of resources. The one or more channel characteristics may include one or more channel strength attributes. The one or more channel strength attributes may include a layer one reference signal received power (L1-RSRP) and a layer one signal to interference noise ratio (L1-SINR).

In one example, the UE may predict a first L1-RSRP value associated with a first resource of the plurality of resources and a second L1-RSRP value associated with a second resource of the plurality of resources based on a first ML model. In another example, the UE may predict a first L1-SINR value associated with the first resource and a second L1-SINR value associated with the second resource based on a second ML model.

The UE further determines a strongest resource (e.g., a reference resource) of the plurality of resources, which is associated with a highest channel characteristic value (e.g., a reference channel characteristic value) in all of the plurality of resources.

The UE further determines channel characteristic values associated with a subset of resources of the plurality of resources. Each resource of the subset of resources is associated with a channel characteristic value that is lower than the reference channel characteristic value. The plurality of resources include the subset of resources and the reference resource.

In certain aspects, each channel characteristic value associated with each resource of the subset of resources may correspond to a differential channel characteristic value relative to the reference channel characteristic value. The UE further performs quantization of each differential channel characteristic value (e.g., relative to the reference channel characteristic value) to a quantity of N bits to generate a corresponding quantized channel characteristic value. In one example, a value of N is defined in wireless standards. In another example, the network entity configures the value of N. In yet another example, the UE configures the value of N.

Each quantized channel characteristic value indicates a value by which a channel characteristic value corresponding to the quantized channel characteristic value is lower than the reference channel characteristic value. For example, each differential channel characteristic value (e.g., relative to the reference channel characteristic value) may be quantized by N bits, which indicates whether the quantized channel characteristic value associated with a corresponding resource is {D₁, D₂, . . . , D₂_{^{N}}}decibel (dB) weaker than the reference resource. In one example, values of {D₁, D₂, . . . , D₂_{^{N}}} are defined in wireless standards. In another example, the network entity configures the values of {D₁, D₂, . . . , D₂_{^{N}}}. In yet another example, the UE configures the values of {D₁, D₂, . . . , D₂_{^{N}}}. In one case, when N is equal to 1, {D₁, D₂} are defined as {less than 6 dB, more than 6 dB}respectively.

In certain aspects, each channel characteristic value associated with each resource (e.g., Kth resource) of the subset of resources may correspond to a differential channel characteristic value relative to a preceding channel characteristic value (e.g., a strongest preceding channel characteristic value) associated with a preceding resource (e.g., (K−1)th strongest preceding resource) of the plurality of resources. The UE further performs quantization of each differential channel characteristic value (e.g., relative to the preceding channel characteristic value) to a quantity of M bits to generate the corresponding quantized channel characteristic value. In one example, a value of M is defined in standards. In another example, the network entity configures the value of M. In yet another example, the UE configures the value of M.

Each quantized channel characteristic value indicates a value by which a channel characteristic value corresponding to the quantized channel characteristic value is lower than the preceding channel characteristic value. For example, each differential channel characteristic value (e.g., relative to the preceding channel characteristic value) is quantized by M bits, which indicates whether the quantized channel characteristic value associated with a corresponding resource is {D₁, D₂, . . . , D₂_{^{M}}}dB weaker than the preceding resource. In one example, values of {D₁, D₂, . . . , D₂_{^{M}}} are defined in standards. In another example, the network entity configures the values of {D₁, D₂, . . . , D₂_{^{M}}}. In another example, the UE configures the values of {D₁, D₂, . . . , D₂_{^{M}}}. In one case, when M is equal to 1 {D₁, D₂} may be defined as {less than 6 dB, more than 6 dB}respectively.

At 730, the UE transmits a report (e.g., a channel state information (CSI) report) that indicates the channel characteristic values associated with the subset of resources to the network entity. The report further indicates a resource identification (ID) associated with each resource of the subset of resources.

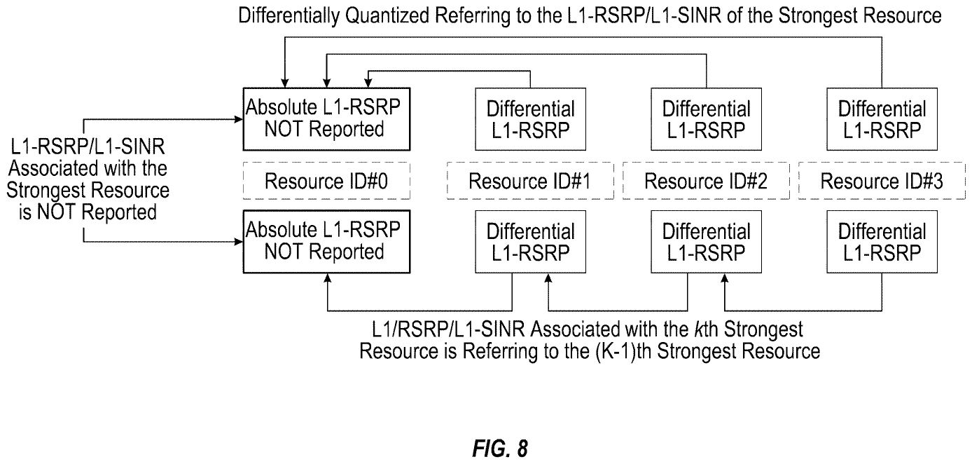

For example, as illustrated in FIG. 8, the UE indicates differentially quantized L1-RSRPs associated with the subset of resources along with resource IDs (e.g., resource ID1, resource ID2, resource ID3) of the subset of resources in the report, while L1-RSRP associated with the strongest resource (e.g., associated with resource ID0) is not indicated in the report. In another example, the UE indicates differentially quantized L1-SINRs associated with the subset of resources along with the resource IDs (e.g., resource ID1, resource ID2, resource ID3) of the subset of resources in the report, while L1-SINR associated with the strongest resource (e.g., associated with resource ID0) is not indicated in the report.

FIG. 9 shows an example of a method 900 for wireless communications at a UE, such as a UE 104 of FIGS. 1 and 3.

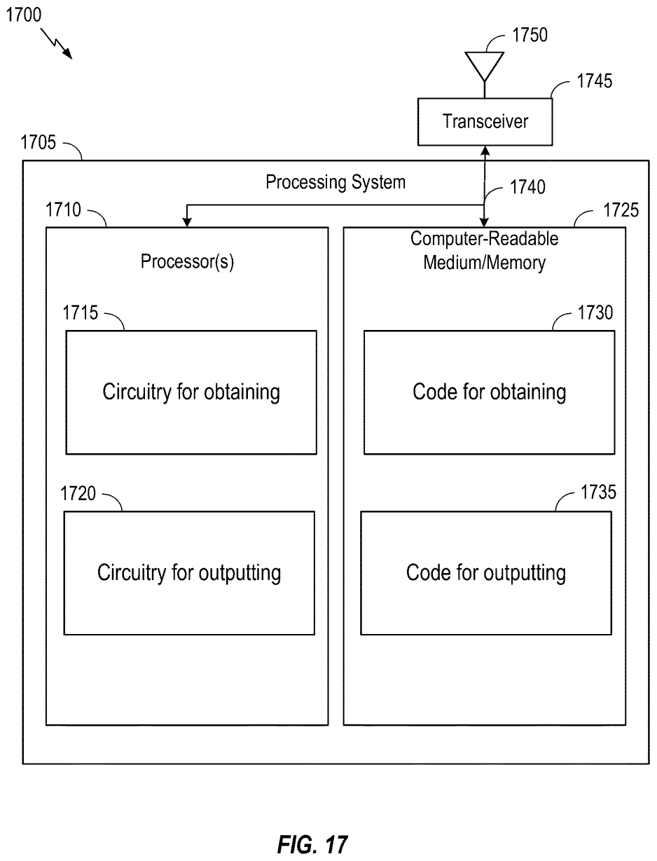

Method 900 begins at step 910 with obtaining a configuration for a plurality of resources corresponding to a plurality of beams. In some cases, the operations of this step refer to, or may be performed by, circuitry for obtaining and/or code for obtaining as described with reference to FIG. 17.

Method 900 then proceeds to step 920 with outputting, for transmission, signaling indicating a report that indicates channel characteristic values associated with a subset of resources of the plurality of resources. Each resource of the subset of resources is associated with a channel characteristic value that is lower than a reference channel characteristic value associated with a reference resource of the plurality of resources. Each channel characteristic value associated with at least one of the plurality of resources is based on a measurement prediction of one or more channel characteristics associated with the at least one of the plurality of resources. In some cases, the operations of this step refer to, or may be performed by, circuitry for outputting and/or code for outputting as described with reference to FIG. 17.

In certain aspects, each channel characteristic value associated with each resource of the subset of resources corresponds to a differential value relative to: the reference channel characteristic value or a preceding channel characteristic value associated with a preceding resource of the plurality of resources.

In certain aspects, method 900 further includes performing quantization of each differential value to generate a corresponding quantized value.

In certain aspects, the report further indicates a resource ID associated with each resource of the subset of resources.

In certain aspects, the one or more channel characteristics further include one or more channel strength attributes, each channel characteristic value further includes at least one of: a L1-RSRP value or a L1-SINR value, and the plurality of resources further include at least one of: a plurality of SSB resources or a plurality of CSI-RS resources.

In certain aspects, each quantized value indicates a value by which a channel characteristic value corresponding to the quantized value is lower than the reference channel characteristic value.

In certain aspects, each quantized value indicates a value by which a channel characteristic value corresponding to the quantized value is lower than the preceding channel characteristic value.

In one aspect, method 900, or any aspect related to it, may be performed by an apparatus, such as communications device 1700 of FIG. 17, which includes various components operable, configured, or adapted to perform the method 900. Communications device 1700 is described below in further detail.

Note that FIG. 9 is just one example of a method, and other methods including fewer, additional, or alternative steps are possible consistent with this disclosure.

FIG. 10 shows an example of a method 1000 for wireless communications at a network entity, such as a BS 102 of FIGS. 1 and 3, or a disaggregated BS as discussed with respect to FIG. 2.

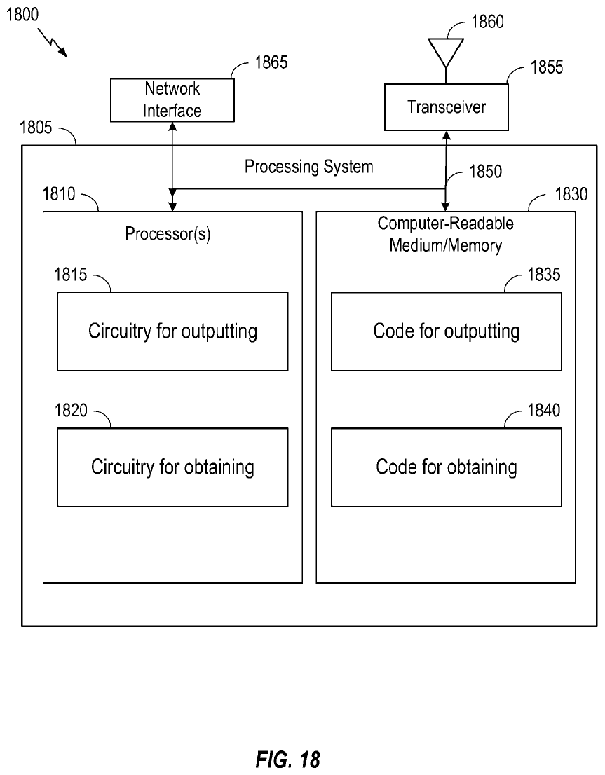

Method 1000 begins at step 1010 with outputting, for transmission, a configuration for a plurality of resources corresponding to a plurality of beams. In some cases, the operations of this step refer to, or may be performed by, circuitry for outputting and/or code for outputting as described with reference to FIG. 18.

Method 1000 then proceeds to step 1020 with obtaining signaling indicating a report that indicates channel characteristic values associated with a subset of resources of the plurality of resources. Each resource of the subset of resources is associated with a channel characteristic value that is lower than a reference channel characteristic value associated with a reference resource of the plurality of resources. Each channel characteristic value associated with at least one of the plurality of resources is based on a measurement prediction of one or more channel characteristics associated with the at least one of the plurality of resources. In some cases, the operations of this step refer to, or may be performed by, circuitry for obtaining and/or code for obtaining as described with reference to FIG. 18.

In certain aspects, each channel characteristic value associated with each resource of the subset of resources corresponds to a differential value relative to: the reference channel characteristic value or a preceding channel characteristic value associated with a preceding resource of the plurality of resources.

In certain aspects, the report further indicates a resource ID associated with each resource of the subset of resources.

In one aspect, method 1000, or any aspect related to it, may be performed by an apparatus, such as communications device 1800 of FIG. 18, which includes various components operable, configured, or adapted to perform the method 1000. Communications device 1800 is described below in further detail.

Note that FIG. 10 is just one example of a method, and other methods including fewer, additional, or alternative steps are possible consistent with this disclosure.

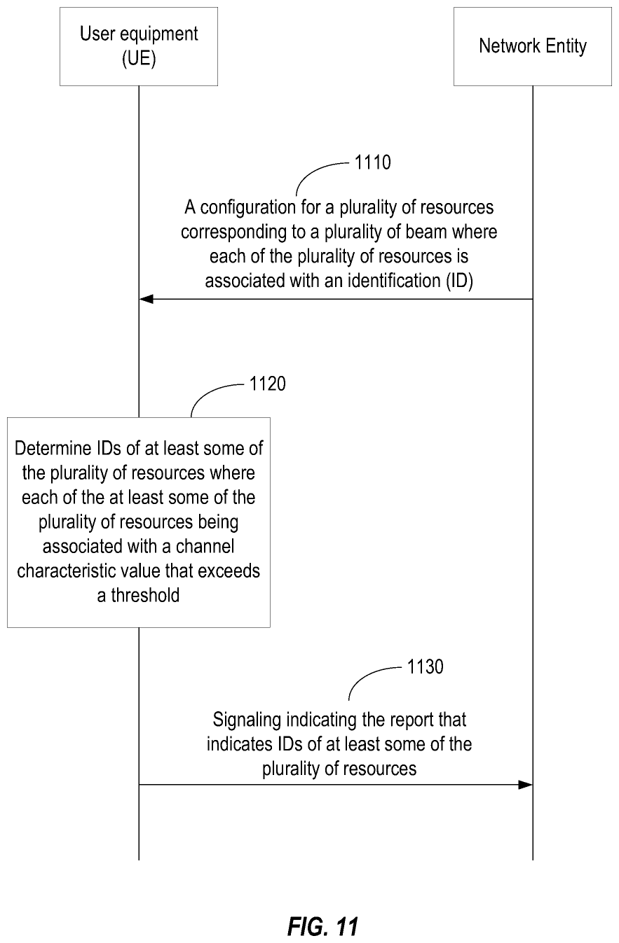

FIG. 11 depicts another call flow diagram illustrating example communication among a UE and a network entity.

At 1110, the network entity transmits a configuration for a plurality of resources corresponding to a plurality of beams. Each of the plurality of resources is associated with an ID. The UE receives the configuration from the network entity. In one example, the plurality of resources may include a plurality of SSB resources. In another example, the plurality of resources may include a plurality of CSI-RS resources.

At 1120, the UE determines a channel characteristic value associated with each resource of the plurality of resources based on a measurement prediction (e.g., via a ML model rather than an actual measurement) of one or more channel characteristics associated with each resource of the plurality of resources. The one or more channel characteristics may include one or more channel strength attributes. The one or more channel strength attributes may include a L1-RSRP and a L1-SINR.

In one example, the UE may predict a first L1-RSRP value associated with a first resource of the plurality of resources and a second L1-RSRP value associated with a second resource of the plurality of resources based on a first ML model. In another example, the UE may predict a first L1-SINR value associated with the first resource and a second L1-SINR value associated with the second resource based on a second ML model.

The UE further determines IDs of at least some of the plurality of resources. Each of the at least some of the plurality of resources is associated with a channel characteristic value that exceeds a threshold. In one example, the UE configures a value of the threshold. In another example, the network entity configures the value of the threshold. In yet another example, the value of the threshold is defined in wireless standards.

At 1130, the UE transmits a report (e.g., a CSI report) that indicates the IDs of the at least some of the plurality of resources to the network entity. For example, the report may indicate whether predicted L1-RSRP values associated with the at least some of the plurality of resources are beyond a certain L1-RSRP threshold. The report may further indicate only the IDs of strongest resources (e.g., in terms of L1-RSRP values) of the plurality of resources, while the actual or predicted L1-RSRP values associated with the strongest resources are not indicated in the report.

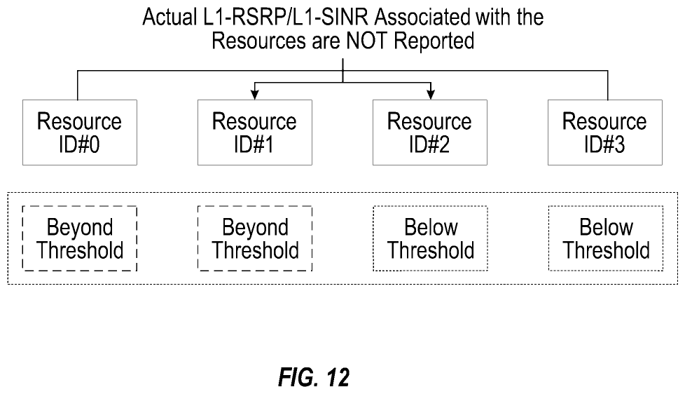

In certain aspects, each resource of the plurality of resources is associated with a single bit indicating whether a channel characteristic value corresponding to the resource exceeds the threshold. In such cases, the report further indicates a plurality of single bits corresponding to the plurality of resources. For example, as illustrated in FIG. 12, the report indicates four bits for four resources (e.g., associated with different IDs including a resource ID0, a resource ID1, a resource ID2, and a resource ID3). In the report, a first bit associated with a first resource with the resource ID0 indicates that a first channel characteristic value corresponding to the first resource exceeds the threshold, a second bit associated with a second resource with the resource ID1 indicates that a second channel characteristic value corresponding to the second resource exceeds the threshold, a third bit associated with a third resource with the resource ID2 indicates that a third channel characteristic value corresponding to the third resource does not exceed the threshold, and a fourth bit associated with a fourth resource with the resource ID3 indicates that a fourth channel characteristic value corresponding to the fourth resource does not exceed the threshold.

In certain aspects, the report further indicates the IDs of the at least some of the plurality of resources arranged in an order according to their channel characteristic values. In one example, the IDs of the at least some of the plurality of resources are ordered according to their L1-RSRP values in the report. In another example, the IDs of the at least some of the plurality of resources are ordered according to their L1-SINR values in the report.

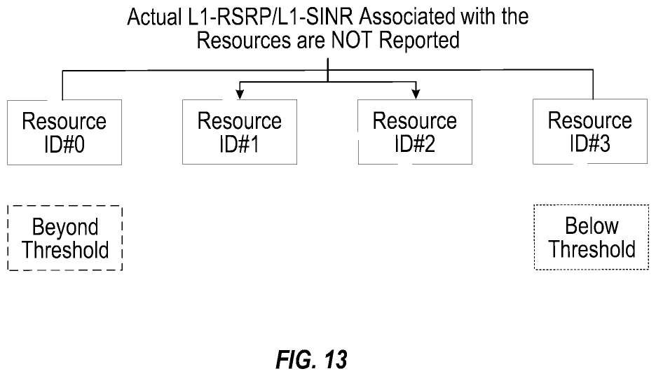

In certain aspects, the report further indicates a first bit associated with a first resource of the plurality of resources. The first bit indicates whether a first channel characteristic value associated with the first resource exceeds the threshold. The first channel characteristic value is higher than each of other channel characteristic values associated with other resources of the plurality of resources. For example, as illustrated in FIG. 13, the report indicates the first bit associated with the first resource, which is a strongest resource (e.g., in terms of its associated first channel characteristic value) among all four resources (e.g., associated with a resource ID0, a resource ID1, a resource ID2, and a resource ID3 respectively). The first resource is associated with the resource ID0.

In certain aspects, the report further indicates a second bit associated with a second resource of the plurality of resources. The second bit indicates whether a second channel characteristic value associated with the second resource exceeds the threshold. The second channel characteristic value is lower than each of the other channel characteristic values associated with the other resources. For example, as further illustrated in FIG. 13, the report indicates the second bit associated with the second resource, which is a weakest resource (e.g., in terms of its associated second channel characteristic value) among all four resources (e.g., associated with a resource ID0, a resource ID1, a resource ID2, and a resource ID3 respectively). The second resource is associated with the resource ID3.

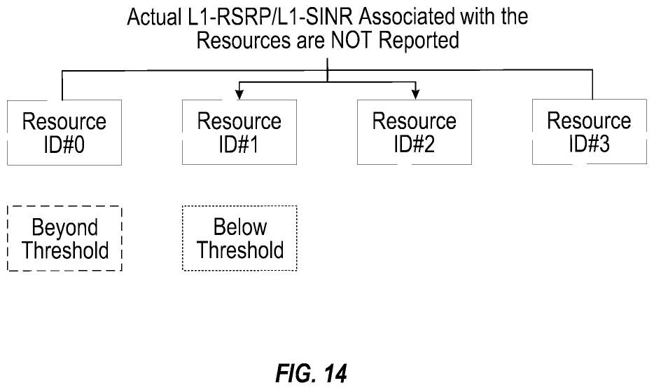

In certain aspects, the report further indicates a first bit associated with a first subset of resources of the plurality of resources. The first bit indicates whether each of first channel characteristic values associated with the first subset of resources exceeds the threshold. Each of the first channel characteristic values is higher than each of other channel characteristic values associated with other resources of the plurality of resources. For example, as illustrated in FIG. 14, the report indicates the first bit associated with the first subset of resources, which are strongest resources (e.g., in terms of their associated channel characteristic values) among all four resources (e.g., associated with a resource ID0, a resource ID1, a resource ID2, and a resource ID3 respectively). In this example, the first subset of resources includes a first resource associated with the resource ID0.

In certain aspects, the UE may receive an indication of a first number associated with the first subset of resources from the network entity. In one example, the network entity configures the first number in a CSI report setting and the CSI report setting is indicated to the UE via a radio resource control (RRC) message. In another example, the UE receives the indication of the first number via a medium access control (MAC) control element (CE) activating the CSI report. In another example, the network entity configures the first number in a CSI report configuration of a aperiodic CSI report and the CSI report configuration is indicated to the UE. In some cases, the UE may determine and report the first number to the network entity. In the example of FIG. 14, the first number is equal to one.

In certain aspects, the report further indicates a second bit associated with a second subset of resources of the plurality of resources. The second bit indicates whether each of second channel characteristic values associated with the second subset of resources exceeds the threshold. Each of the second channel characteristic values is lower than each of the other channel characteristic values associated with the other resources. For example, as further illustrated in FIG. 14, the report indicates the second bit associated with the second subset of resources, which are weakest resources (e.g., in terms of their associated channel characteristic values) among all four resources (e.g., associated with a resource ID0, a resource ID1, a resource ID2, and a resource ID3 respectively). In this example, the second subset of resources includes a second resource associated with the resource ID1.

In certain aspects, the UE may receive an indication of a second number associated with the second subset of resources from the network entity. In one example, the network entity configures the second number in the CSI report setting and the CSI report setting is indicated to the UE via the RRC message. In another example, the UE receives the indication of the second number via the MAC-CE activating the CSI report. In another example, the network entity configures the second number in the CSI report configuration of the aperiodic CSI report and the CSI report configuration is indicated to the UE. In some cases, the UE may determine and report the second number to the network entity. In the example of FIG. 14, the second number is equal to one.

In certain aspects, the network entity configures a value of the threshold in a CSI report setting and the CSI report setting is indicated to the UE via an RRC message. In certain aspects, the UE receives the indication of the value of the threshold via a MAC-CE activating the CSI report. In certain aspects, the network entity configures the value of the threshold in a CSI report configuration of a aperiodic CSI report and the CSI report configuration is indicated to the UE.

In certain aspects, the report further indicates the value of the threshold. For example, the value of the threshold may be reported by the UE in the CSI report or semi-persistently updated via a MAC-CE. In some cases, uplink control information (UCI)/MAC-CE based CSI report may further be based on one of network configured and/or indicated multiple thresholds.

In certain aspects, the report further indicates channel characteristic values associated with a subset of the resources of the plurality of resources. Each resource of the subset of resources is associated with a channel characteristic value that is lower than a reference channel characteristic value associated with a reference resource of the plurality of resources. Each channel characteristic value associated with each resource of the subset of resources corresponds to a differential value relative to the reference channel characteristic value or a preceding channel characteristic value associated with a preceding resource of the plurality of resources. The UE further performs quantization of each differential value to generate a corresponding quantized value.

FIG. 15 shows an example of a method 1500 for wireless communications at a UE, such as a UE 104 of FIGS. 1 and 3.

Method 1500 begins at step 1510 with obtaining a configuration for a plurality of resources corresponding to a plurality of beams where each of the plurality of resources is associated with an ID. In some cases, the operations of this step refer to, or may be performed by, circuitry for obtaining and/or code for obtaining as described with reference to FIG. 18.

Method 1500 then proceeds to step 1520 with outputting, for transmission, signaling indicating a report that indicates IDs of at least some of the plurality of resources. Each of the at least some of the plurality of resources being associated with a channel characteristic value that exceeds a threshold. Each channel characteristic value associated with at least one of the plurality of resources is based on a measurement prediction of one or more channel characteristics associated with the at least one of the plurality of resources. In some cases, the operations of this step refer to, or may be performed by, circuitry for outputting and/or code for outputting as described with reference to FIG. 18.

In certain aspects, the one or more channel characteristics further include one or more channel strength attributes; each channel characteristic value further includes at least one of: a L1-RSRP value or a L1-SINR value; and the plurality of resources further include at least one of: a plurality of SSB resources or a plurality of CSI-RS resources.

In certain aspects, each resource of the plurality of resources is associated with a single bit indicating whether a channel characteristic value corresponding to the resource exceeds the threshold, and the report further indicates a plurality of single bits corresponding to the plurality of resources.

In certain aspects, the report further indicates the IDs of the at least some of the plurality of resources arranged in an order according to their channel characteristic values.

In certain aspects, the report further indicates a first bit associated with a first resource of the plurality of resources, said first bit indicating whether a first channel characteristic value associated with the first resource exceeds the threshold, the first channel characteristic value being higher than each of other channel characteristic values associated with other resources of the plurality of resources and/or the report further indicates a second bit associated with a second resource of the plurality of resources, said second bit indicating whether a second channel characteristic value associated with the second resource exceeds the threshold, the second channel characteristic value being lower than each of the other channel characteristic values associated with the other resources.

In certain aspects, the report further indicates a first bit associated with a first subset of resources of the plurality of resources, said first bit indicating whether each of first channel characteristic values associated with the first subset of resources exceeds the threshold, each of the first channel characteristic values being higher than each of other channel characteristic values associated with other resources of the plurality of resources and/or the report further indicates a second bit associated with a second subset of resources of the plurality of resources, said second bit indicating whether each of second channel characteristic values associated with the second subset of resources exceeds the threshold, each of the second channel characteristic values being lower than each of the other channel characteristic values associated with the other resources.

In certain aspects, the report further indicates a value of the threshold.

In certain aspects, the report further indicates channel characteristic values associated with a subset of the resources of the plurality of resources, each resource of the subset of resources is associated with a channel characteristic value that is lower than a reference channel characteristic value associated with a reference resource of the plurality of resources, each channel characteristic value associated with each resource of the subset of resources corresponds to a differential value relative to: the reference channel characteristic value or a preceding channel characteristic value associated with a preceding resource of the plurality of resources, and method 1500 further includes performing quantization of each differential value to generate a corresponding quantized value.

In one aspect, method 1500, or any aspect related to it, may be performed by an apparatus, such as communications device 1700 of FIG. 17, which includes various components operable, configured, or adapted to perform the method 1500. Communications device 1700 is described below in further detail.

Note that FIG. 15 is just one example of a method, and other methods including fewer, additional, or alternative steps are possible consistent with this disclosure.

FIG. 16 shows an example of a method 1600 for wireless communications at a network entity, such as a BS 102 of FIGS. 1 and 3, or a disaggregated BS as discussed with respect to FIG. 2.

Method 1600 begins at step 1610 with outputting, for transmission, a configuration for a plurality of resources corresponding to a plurality of beams where each of the plurality of resources is associated with an ID. In some cases, the operations of this step refer to, or may be performed by, circuitry for outputting and/or code for outputting as described with reference to FIG. 18.

Method 1600 then proceeds to step 1620 with obtaining signaling indicating a report that indicates IDs of at least some of the plurality of resources. Each of the at least some of the plurality of resources being associated with a channel characteristic value that exceeds a threshold. Each channel characteristic value associated with at least one of the plurality of resources is based on a measurement prediction of one or more channel characteristics associated with the at least one of the plurality of resource. In some cases, the operations of this step refer to, or may be performed by, circuitry for obtaining and/or code for obtaining as described with reference to FIG. 18.

In certain aspects, the one or more channel characteristics further include one or more channel strength attributes, each channel characteristic value further includes at least one of: a L1-RSRP value or a L1-SINR value, and the plurality of resources further include at least one of: a plurality of SSB resources or a plurality of CSI-RS resources.

In one aspect, method 1600, or any aspect related to it, may be performed by an apparatus, such as communications device 1800 of FIG. 18, which includes various components operable, configured, or adapted to perform the method 1000. Communications device 1800 is described below in further detail.

Note that FIG. 16 is just one example of a method, and other methods including fewer, additional, or alternative steps are possible consistent with this disclosure.

In certain aspects, the UE determines and reports a payload (e.g., a layer 1 (L1) payload) of or associated with a report (e.g., a CSI report including predicted L1-RSRP values and/or L1-SINR values) to the network entity. In certain aspects, the network entity determines and reports the payload to the UE.

In certain aspects, the UE determines and transmits one or more report configurations or settings for a report to the network entity. In certain aspects, the UE receives an indication of the one or more report configurations from the network entity. The one or more report configurations may include a first report configuration, a second report configuration, a third report configuration, a fourth report configuration, and a fifth report configuration.

The first report configuration indicates a report quantity (or size) for both predicted (and absolute) channel characteristic values of all resources of the plurality of resources and IDs of the all resources.

The second report configuration indicates a report quantity for the subset of resources (e.g., each resource of the subset of resources is associated with the predicted channel characteristic value that is lower than the predicted reference channel characteristic value) and IDs of the subset of resources.

The third report configuration indicates a report quantity for the at least some of the plurality of resources (e.g., each of the at least some of the plurality of resources being associated with the predicted channel characteristic value that exceeds the threshold) and IDs of the at least some of the plurality of resources.

The fourth report configuration indicates a report quantity for the subset of resources (e.g., each resource of the subset of resources is associated with the predicted channel characteristic value that is lower than the predicted reference channel characteristic value), the IDs of the subset of resources, the at least some of the plurality of resources (e.g., each of the at least some of the plurality of resources being associated with the predicted channel characteristic value that exceeds the threshold), and the IDs of the at least some of the plurality of resources.

The fifth report configuration indicates a report quantity for IDs of a set of strongest resources (e.g., in terms of their predicted channel characteristic values) of the plurality of resources.

In certain aspects, the first report configuration, the second report configuration, the third report configuration, the fourth report configuration, and the fifth report configuration may be linked to each other.

In certain aspects, at least one of the first report configuration, the second report configuration, the third report configuration, the fourth report configuration, or the fifth report configuration may include IDs corresponding to other report configurations. In some cases, the report configurations may share identical prediction resource set(s) and/or identical channel measurement resource (CMR) set(s).

In certain aspects, the UE recommends a switch among different report configurations associated with a report to the network entity. In one example, the UE may send the switch recommendation to the network entity via uplink control information (UCI). The UCI may indicate a field (e.g., as a report quantity), which indicates UE recommendations on whether to switch to an alternatively linked report configuration. In another example, the UE may send the switch recommendation to the network entity via a MAC-CE or an RRC message.

In certain aspects, the UE sends the recommendation to the switch among the different report configurations, based on processing of information in wireless standards, network entity configuration, and/or a capability of the UE (e.g., depending on a confidence level threshold associated with one or more predicted channel characteristic values corresponding to one or more resources).

In certain aspects, the network entity may manage a process to switch among the different report configurations.

In certain aspects, the report quantity indicated via the first report configuration may include confidence levels (e.g., channel characteristic prediction confidence levels) associated with one or more predicted channel characteristic values corresponding to one or more resources. In one example, a channel characteristic prediction confidence level of a strongest predicted resource (e.g., indicated in a first report based on the first report configuration) is also indicated in the first report. In another example, channel characteristic prediction confidence level(s) of all predicted resources (e.g., indicated in the first report) are also indicated in the first report. In another example, differential channel characteristic prediction confidence level(s) associated with a subset of resources of a plurality of resources are indicated in a second report based on the second report configuration or a fourth report based on the fourth report configuration. In another example, channel characteristic prediction confidence level(s) associated with whether predicted channel characteristic values are beyond a threshold are indicated in a third report based on the third report configuration or the fourth report. In another example, a channel characteristic prediction confidence level is quantized with a small number of bits (e.g., N number of bits) such that any additional report overhead is limited.

In certain aspects, the network entity may determine whether the UE has to switch to another report configuration based on one or more confidence levels indicated to the network entity by the UE.

In certain aspects, multiple report configurations may correspond to multiple MAC-CEs. For example, a first report configuration corresponds to a first MAC-CE and a second report configuration corresponds to a second MAC-CE. In such cases, the network entity may use an RRC message, a MAC-CE, or DCI to control the UE to send a report through a specific MAC-CE/report configuration. The UE may send the report to the network entity in the network entity ordered MAC-CE/report configuration or through separate UCI, MAC-CE, or RRC signaling on whether the UE would switch to another MAC-CE/report configuration.

### Example Communications Devices

FIG. 17 depicts aspects of an example communications device 1700. In some aspects, communications device 1700 is a user equipment (UE), such as UE 104 described above with respect to FIGS. 1 and 3.

The communications device 1700 includes a processing system 1705 coupled to the transceiver 1745 (e.g., a transmitter and/or a receiver). The transceiver 1745 is configured to transmit and receive signals for the communications device 1700 via the antenna 1750, such as the various signals as described herein. The processing system 1705 may be configured to perform processing functions for the communications device 1700, including processing signals received and/or to be transmitted by the communications device 1700.

The processing system 1705 includes one or more processors 1710. In various aspects, the one or more processors 1710 may be representative of one or more of receive processor 358, transmit processor 364, TX MIMO processor 366, and/or controller/processor 380, as described with respect to FIG. 3. The one or more processors 1710 are coupled to a computer-readable medium/memory 1725 via a bus 1740. In certain aspects, the computer-readable medium/memory 1725 is configured to store instructions (e.g., computer-executable code) that when executed by the one or more processors 1710, cause the one or more processors 1710 to perform the method 900 described with respect to FIG. 9, the method 1500 described with respect to FIG. 15, and/or any aspect related to it. Note that reference to a processor performing a function of communications device 1700 may include one or more processors 1710 performing that function of communications device 1700.

In the depicted example, computer-readable medium/memory 1725 stores code (e.g., executable instructions), such as code for obtaining 1730 and code for outputting 1735. Processing of the code for obtaining 1730 and code for outputting 1735 may cause the communications device 1700 to perform the method 900 described with respect to FIG. 9, the method 1500 described with respect to FIG. 15, and/or any aspect related to it.

The one or more processors 1710 include circuitry configured to implement (e.g., execute) the code stored in the computer-readable medium/memory 1725, including circuitry such as circuitry for obtaining 1715 and circuitry for outputting 1720. Processing with circuitry for obtaining 1715 and circuitry for outputting 1720 may cause the communications device 1700 to perform the method 900 described with respect to FIG. 9, the method 1500 described with respect to FIG. 15, and/or any aspect related to it.

Various components of the communications device 1700 may provide means for performing the method 900 described with respect to FIG. 9, the method 1500 described with respect to FIG. 15, and/or any aspect related to it. For example, means for transmitting, sending or outputting for transmission may include transceivers 354 and/or antenna(s) 352 of the UE 104 illustrated in FIG. 3 and/or the circuitry for outputting 1720, the code for outputting 1735, the transceiver 1745 and the antenna 1750 of the communications device 1700 in FIG. 17. Means for receiving or obtaining may include transceivers 354 and/or antenna(s) 352 of the UE 104 illustrated in FIG. 3 and/or the circuitry for obtaining 1715, the code for obtaining 1730, the transceiver 1745 and the antenna 1750 of the communications device 1700 in FIG. 17.

In some cases, rather than actually transmitting, for example, signals and/or data, a device may have an interface to output signals and/or data for transmission (a means for outputting). For example, a processor may output signals and/or data, via a bus interface, to a radio frequency (RF) front end for transmission. In various aspects, an RF front end may include various components, including transmit and receive processors, transmit and receive MIMO processors, modulators, demodulators, and the like, such as depicted in the examples in FIG. 3.

In some cases, rather than actually receiving signals and/or data, a device may have an interface to obtain the signals and/or data received from another device (a means for obtaining). For example, a processor may obtain (or receive) the signals and/or data, via a bus interface, from an RF front end for reception. In various aspects, an RF front end may include various components, including transmit and receive processors, transmit and receive MIMO processors, modulators, demodulators, and the like, such as depicted in the examples in FIG. 3. Notably, FIG. 17 is an example, and many other examples and configurations of communication device 1700 are possible.

FIG. 18 depicts aspects of an example communications device 1800. In some aspects, communications device 1800 is a network entity, such as BS 102 of FIGS. 1 and 3, or a disaggregated base station as discussed with respect to FIG. 2.

The communications device 1800 includes a processing system 1805 coupled to the transceiver 1855 (e.g., a transmitter and/or a receiver) and/or a network interface 1865. The transceiver 1855 is configured to transmit and receive signals for the communications device 1800 via the antenna 1860, such as the various signals as described herein. The network interface 1865 is configured to obtain and send signals for the communications device 1800 via communication link(s), such as a backhaul link, midhaul link, and/or fronthaul link as described herein, such as with respect to FIG. 2. The processing system 1805 may be configured to perform processing functions for the communications device 1800, including processing signals received and/or to be transmitted by the communications device 1800.

The processing system 1805 includes one or more processors 1810. In various aspects, one or more processors 1810 may be representative of one or more of receive processor 338, transmit processor 320, TX MIMO processor 330, and/or controller/processor 340, as described with respect to FIG. 3. The one or more processors 1810 are coupled to a computer-readable medium/memory 1830 via a bus 1850. In certain aspects, the computer-readable medium/memory 1830 is configured to store instructions (e.g., computer-executable code) that when executed by the one or more processors 1810, cause the one or more processors 1810 to perform the method 1000 described with respect to FIG. 10, the method 1600 described with respect to FIG. 16, or any aspect related to it. Note that reference to a processor of communications device 1800 performing a function may include one or more processors 1810 of communications device 1800 performing that function.

In the depicted example, the computer-readable medium/memory 1830 stores code (e.g., executable instructions), such as code for outputting 1835 and code for obtaining 1840. Processing of the code for outputting 1835 and code for obtaining 1840 may cause the communications device 1800 to perform the method 1000 described with respect to FIG. 10, the method 1600 described with respect to FIG. 16, or any aspect related to it.

The one or more processors 1810 include circuitry configured to implement (e.g., execute) the code stored in the computer-readable medium/memory 1830, including circuitry such as circuitry for outputting 1815 and circuitry for obtaining 1820. Processing with circuitry for outputting 1815 and circuitry for obtaining 1820 may cause the communications device 1800 to perform the method 1000 described with respect to FIG. 10, the method 1600 described with respect to FIG. 16, or any aspect related to it.

Various components of the communications device 1800 may provide means for performing the method 1000 described with respect to FIG. 10, the method 1600 described with respect to FIG. 16, or any aspect related to it. Means for transmitting, sending or outputting for transmission may include transceivers 332 and/or antenna(s) 334 of the BS 102 illustrated in FIG. 3 and/or the circuitry for outputting 1815, the code for outputting 1835, the transceiver 1855 and the antenna 1860 of the communications device 1800 in FIG. 18. Means for receiving or obtaining may include transceivers 332 and/or antenna(s) 334 of the BS 102 illustrated in FIG. 3 and/or the circuitry for obtaining 1820, the code for obtaining 1840, the transceiver 1855 and the antenna 1860 of the communications device 1800 in FIG. 18.

In some cases, rather than actually transmitting, for example, signals and/or data, a device may have an interface to output signals and/or data for transmission (a means for outputting). For example, a processor may output signals and/or data, via a bus interface, to an RF front end for transmission. In various aspects, an RF front end may include various components, including transmit and receive processors, transmit and receive MIMO processors, modulators, demodulators, and the like, such as depicted in the examples in FIG. 3.

In some cases, rather than actually receiving signals and/or data, a device may have an interface to obtain the signals and/or data received from another device (a means for obtaining). For example, a processor may obtain (or receive) the signals and/or data, via a bus interface, from an RF front end for reception. In various aspects, an RF front end may include various components, including transmit and receive processors, transmit and receive MIMO processors, modulators, demodulators, and the like, such as depicted in the examples in FIG. 3. Notably, FIG. 18 is an example, and many other examples and configurations of communication device 1800 are possible.

### Example Clauses

Implementation examples are described in the following numbered clauses:

Clause 1: A method for wireless communications at a user equipment (UE), comprising: obtaining a configuration for a plurality of resources corresponding to a plurality of beams; and outputting, for transmission, signaling indicating a report that indicates channel characteristic values associated with a subset of resources of the plurality of resources, wherein each resource of the subset of resources is associated with a channel characteristic value that is lower than a reference channel characteristic value associated with a reference resource of the plurality of resources, and wherein each channel characteristic value associated with at least one of the plurality of resources is based on a measurement prediction of one or more channel characteristics associated with the at least one of the plurality of resources.

Clause 2: The method of clause 1, wherein each channel characteristic value associated with each resource of the subset of resources corresponds to a differential value relative to: the reference channel characteristic value or a preceding channel characteristic value associated with a preceding resource of the plurality of resources.

Clause 3: The method of any one of clauses 1-2, further comprising performing quantization of each differential value to generate a corresponding quantized value.

Clause 4: The method of any one of clauses 1-3, wherein the report further indicates a resource identification (ID) associated with each resource of the subset of resources.

Clause 5: The method of any one of clauses 1-4, wherein: the one or more channel characteristics further comprise one or more channel strength attributes; each channel characteristic value further comprises at least one of: a layer one reference signal received power (L1-RSRP) value or a layer one signal to interference noise ratio (L1-SINR) value; and the plurality of resources further comprise at least one of: a plurality of synchronization signal block (SSB) resources or a plurality of CSI reference signal (CSI-RS) resources.

Clause 6: The method of clause 3, wherein each quantized value indicates a value by which a channel characteristic value corresponding to the quantized value is lower than the reference channel characteristic value.

Clause 7: The method of clause 3, wherein each quantized value indicates a value by which a channel characteristic value corresponding to the quantized value is lower than the preceding channel characteristic value.

Clause 8: A method for wireless communications at a network entity, comprising: outputting, for transmission, a configuration for a plurality of resources corresponding to a plurality of beams; and obtaining signaling indicating a report that indicates channel characteristic values associated with a subset of resources of the plurality of resources, wherein each resource of the subset of resources is associated with a channel characteristic value that is lower than a reference channel characteristic value associated with a reference resource of the plurality of resources, and wherein each channel characteristic value associated with at least one of the plurality of resources is based on a measurement prediction of one or more channel characteristics associated with the at least one of the plurality of resources.

Clause 9: The method of clause 8, wherein each channel characteristic value associated with each resource of the subset of resources corresponds to a differential value relative to: the reference channel characteristic value or a preceding channel characteristic value associated with a preceding resource of the plurality of resources.

Clause 10: The method of any one of clauses 8-9, wherein the report further indicates a resource identification (ID) associated with each resource of the subset of resources.

Clause 11: A method for wireless communications at a user equipment (UE), comprising: obtaining a configuration for a plurality of resources corresponding to a plurality of beams, wherein each of the plurality of resources is associated with an identification (ID); and outputting, for transmission, signaling indicating a report that indicates IDs of at least some of the plurality of resources, each of the at least some of the plurality of resources being associated with a channel characteristic value that exceeds a threshold, and wherein each channel characteristic value associated with at least one of the plurality of resources is based on a measurement prediction of one or more channel characteristics associated with the at least one of the plurality of resources.

Clause 12: The method of clause 11, wherein: the one or more channel characteristics further comprise one or more channel strength attributes; each channel characteristic value further comprises at least one of: a layer one reference signal received power (L1-RSRP) value or a layer one signal to interference noise ratio (L1-SINR) value; and the plurality of resources further comprise at least one of: a plurality of synchronization signal block (SSB) resources or a plurality of channel state information—reference signal (CSI-RS) resources.

Clause 13: The method of any one of clauses 11-12, wherein: each resource of the plurality of resources is associated with a single bit indicating whether a channel characteristic value corresponding to the resource exceeds the threshold; and the report further indicates a plurality of single bits corresponding to the plurality of resources.

Clause 14: The method of any one of clauses 11-13, wherein the report further indicates the IDs of the at least some of the plurality of resources arranged in an order according to their channel characteristic values.

Clause 15: The method of any one of clauses 11-14, wherein at least one of: the report further indicates a first bit associated with a first resource of the plurality of resources, said first bit indicating whether a first channel characteristic value associated with the first resource exceeds the threshold, the first channel characteristic value being higher than each of other channel characteristic values associated with other resources of the plurality of resources; or the report further indicates a second bit associated with a second resource of the plurality of resources, said second bit indicating whether a second channel characteristic value associated with the second resource exceeds the threshold, the second channel characteristic value being lower than each of the other channel characteristic values associated with the other resources.

Clause 16: The method of any one of clauses 11-15, wherein at least one of: the report further indicates a first bit associated with a first subset of resources of the plurality of resources, said first bit indicating whether each of first channel characteristic values associated with the first subset of resources exceeds the threshold, each of the first channel characteristic values being higher than each of other channel characteristic values associated with other resources of the plurality of resources; or the report further indicates a second bit associated with a second subset of resources of the plurality of resources, said second bit indicating whether each of second channel characteristic values associated with the second subset of resources exceeds the threshold, each of the second channel characteristic values being lower than each of the other channel characteristic values associated with the other resources.

Clause 17: The method of any one of clauses 11-16, wherein the report further indicates a value of the threshold.

Clause 18: The method of any one of clauses 11-17, wherein: the report further indicates channel characteristic values associated with a subset of the resources of the plurality of resources, each resource of the subset of resources is associated with a channel characteristic value that is lower than a reference channel characteristic value associated with a reference resource of the plurality of resources; each channel characteristic value associated with each resource of the subset of resources corresponds to a differential value relative to: the reference channel characteristic value or a preceding channel characteristic value associated with a preceding resource of the plurality of resources; and performing quantization of each differential value to generate a corresponding quantized value.

Clause 19: A method for wireless communications at a network entity, comprising: outputting, for transmission, a configuration for a plurality of resources corresponding to a plurality of beams, wherein each of the plurality of resources is associated with an identification (ID); and obtaining signaling indicating a report that indicates IDs of at least some of the plurality of resources, each of the at least some of the plurality of resources being associated with a channel characteristic value that exceeds a threshold, and wherein each channel characteristic value associated with at least one of the plurality of resources is based on a measurement prediction of one or more channel characteristics associated with the at least one of the plurality of resources.

Clause 20: The method of clause 19, wherein: the one or more channel characteristics further comprise one or more channel strength attributes; each channel characteristic value further comprises at least one of: a layer one reference signal received power (L1-RSRP) value or a layer one signal to interference noise ratio (L1-SINR) value; and the plurality of resources further comprise at least one of: a plurality of synchronization signal block (SSB) resources or a plurality of channel state information—reference signal (CSI-RS) resources.

Clause 21: The method of any one of clauses 19-20, wherein: each resource of the plurality of resources is associated with a single bit indicating whether a channel characteristic value corresponding to the resource exceeds the threshold; and the report further indicates a plurality of single bits corresponding to the plurality of resources.

Clause 22: The method of any one of clauses 19-21, wherein the report further indicates the IDs of the at least some of the plurality of resources arranged in an order according to their channel characteristic values.

Clause 23: The method of any one of clauses 19-22, wherein at least one of: the report further indicates a first bit associated with a first resource of the plurality of resources, said first bit indicating whether a first channel characteristic value associated with the first resource exceeds the threshold, the first channel characteristic value being higher than each of other channel characteristic values associated with other resources of the plurality of resources; or the report further indicates a second bit associated with a second resource of the plurality of resources, said second bit indicating whether a second channel characteristic value associated with the second resource exceeds the threshold, the second channel characteristic value being lower than each of the other channel characteristic values associated with the other resources.

Clause 24: The method of any one of clauses 19-23, wherein at least one of: the report further indicates a first bit associated with a first subset of resources of the plurality of resources, said first bit indicating whether each of first channel characteristic values associated with the first subset of resources exceeds the threshold, each of the first channel characteristic values being higher than each of other channel characteristic values associated with other resources of the plurality of resources; or the report further indicates a second bit associated with a second subset of resources of the plurality of resources, said second bit indicating whether each of second channel characteristic values associated with the second subset of resources exceeds the threshold, each of the second channel characteristic values being lower than each of the other channel characteristic values associated with the other resources.

Clause 25: The method of any one of clauses 19-24, wherein the report further indicates a value of the threshold.

Clause 26: An apparatus, comprising: a memory comprising executable instructions; and a processor configured to execute the executable instructions and cause the apparatus to perform a method in accordance with any one of Clauses 1-25.

Clause 27: An apparatus, comprising means for performing a method in accordance with any one of Clauses 1-25.

Clause 28: A non-transitory computer-readable medium comprising executable instructions that, when executed by a processor of an apparatus, cause the apparatus to perform a method in accordance with any one of Clauses 1-25.

Clause 29: A computer program product embodied on a computer-readable storage medium comprising code for performing a method in accordance with any one of Clauses 1-25.

Clause 30: A user equipment (UE), comprising: at least one transceiver; a memory comprising executable instructions; and a processor configured to execute the executable instructions and cause the UE to perform a method in accordance with any one of Clauses 1-7, wherein the at least one transceiver is configured to: receive the configuration for the plurality of resources corresponding to the plurality of beams; and transmit the signaling indicating the report that indicates the channel characteristic values associated with the subset of resources of the plurality of resources.

Clause 31: A network entity, comprising: at least one transceiver; a memory comprising executable instructions; and a processor configured to execute the executable instructions and cause the network entity to perform a method in accordance with any one of Clauses 8-10, wherein the at least one transceiver is configured to: transmit the configuration for the plurality of resources corresponding to the plurality of beams; and receive the signaling indicating the report that indicates the channel characteristic values associated with the subset of resources of the plurality of resources.

Clause 32: A user equipment (UE), comprising: at least one transceiver; a memory comprising executable instructions; and a processor configured to execute the executable instructions and cause the UE to perform a method in accordance with any one of Clauses 11-18, wherein the at least one transceiver is configured to: receive the configuration for the plurality of resources corresponding to the plurality of beams; and transmit the signaling indicating the report that indicates the IDs of the at least some of the plurality of resources.

Clause 33: A network entity, comprising: at least one transceiver; a memory comprising executable instructions; and a processor configured to execute the executable instructions and cause the network entity to perform a method in accordance with any one of Clauses 19-25, wherein the at least one transceiver is configured to: transmit the configuration for the plurality of resources corresponding to the plurality of beams; and receive the signaling indicating the report that indicates the IDs of the at least some of the plurality of resources.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a general purpose processor, a digital signal processor (DSP), an ASIC, a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a system on a chip (SoC), or any other such configuration.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for”. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

1. An apparatus for wireless communications, comprising:
a memory comprising computer-executable instructions; and
a processor configured to execute the computer-executable instructions and cause the apparatus to:
obtain a configuration for a plurality of resources corresponding to a plurality of beams; and
output, for transmission, signaling indicating a report that indicates channel characteristic values associated with a subset of resources of the plurality of resources, wherein each resource of the subset of resources is associated with a channel characteristic value that is lower than a reference channel characteristic value associated with a reference resource of the plurality of resources, and wherein each channel characteristic value associated with at least one of the plurality of resources is based on a measurement prediction of one or more channel characteristics associated with the at least one of the plurality of resources.

2. The apparatus of claim 1, wherein each channel characteristic value associated with each resource of the subset of resources corresponds to a differential value relative to: the reference channel characteristic value or a preceding channel characteristic value associated with a preceding resource of the plurality of resources.

3. The apparatus of claim 2, wherein the processor is further configured to execute the computer-executable instructions and cause the apparatus to perform quantization of each differential value to generate a corresponding quantized value.

4. The apparatus of claim 1, wherein the report further indicates a resource identification (ID) associated with each resource of the subset of resources.

5. The apparatus of claim 1, wherein:
the one or more channel characteristics further comprise one or more channel strength attributes;
each channel characteristic value further comprises at least one of: a layer one reference signal received power (L1-RSRP) value or a layer one signal to interference noise ratio (L1-SINR) value; and
the plurality of resources further comprise at least one of: a plurality of synchronization signal block (SSB) resources or a plurality of CSI reference signal (CSI-RS) resources.

6. The apparatus of claim 3, wherein each quantized value indicates a value by which a channel characteristic value corresponding to the quantized value is lower than the reference channel characteristic value.

7. The apparatus of claim 3, wherein each quantized value indicates a value by which a channel characteristic value corresponding to the quantized value is lower than the preceding channel characteristic value.

8. The apparatus of claim 1, further comprising at least one transceiver configured to at least one of: receive the configuration or transmit the report, wherein the apparatus is configured as a user equipment (UE).

9. An apparatus for wireless communications, comprising:
a memory comprising computer-executable instructions; and
a processor configured to execute the computer-executable instructions and cause the apparatus to:
output, for transmission, a configuration for a plurality of resources corresponding to a plurality of beams; and
obtain signaling indicating a report that indicates channel characteristic values associated with a subset of resources of the plurality of resources, wherein each resource of the subset of resources is associated with a channel characteristic value that is lower than a reference channel characteristic value associated with a reference resource of the plurality of resources, and wherein each channel characteristic value associated with at least one of the plurality of resources is based on a measurement prediction of one or more channel characteristics associated with the at least one of the plurality of resources.

10. The apparatus of claim 9, wherein at least one of:
each channel characteristic value associated with each resource of the subset of resources corresponds to a differential value relative to: the reference channel characteristic value or a preceding channel characteristic value associated with a preceding resource of the plurality of resources; or
the report further indicates a resource identification (ID) associated with each resource of the subset of resources.

11. The apparatus of claim 9, further comprising at least one transceiver configured to at least one of: transmit the configuration or receive the report, wherein the apparatus is configured as a network entity.

12. An apparatus for wireless communications, comprising:
a memory comprising computer-executable instructions; and
a processor configured to execute the computer-executable instructions and cause the apparatus to:
obtain a configuration for a plurality of resources corresponding to a plurality of beams, wherein each of the plurality of resources is associated with an identification (ID); and
output, for transmission, signaling indicating a report that indicates IDs of at least some of the plurality of resources, each of the at least some of the plurality of resources being associated with a channel characteristic value that exceeds a threshold, and wherein each channel characteristic value associated with at least one of the plurality of resources is based on a measurement prediction of one or more channel characteristics associated with the at least one of the plurality of resources.

13. The apparatus of claim 12, wherein:
the one or more channel characteristics further comprise one or more channel strength attributes;
each channel characteristic value further comprises at least one of: a layer one reference signal received power (L1-RSRP) value or a layer one signal to interference noise ratio (L1-SINR) value; and
the plurality of resources further comprise at least one of: a plurality of synchronization signal block (SSB) resources or a plurality of channel state information—reference signal (CSI-RS) resources.

14. The apparatus of claim 12, wherein:
each resource of the plurality of resources is associated with a single bit indicating whether a channel characteristic value corresponding to the resource exceeds the threshold; and
the report further indicates a plurality of single bits corresponding to the plurality of resources.

15. The apparatus of claim 12, wherein the report further indicates the IDs of the at least some of the plurality of resources arranged in an order according to their channel characteristic values.

16. The apparatus of claim 12, wherein at least one of:
the report further indicates a first bit associated with a first resource of the plurality of resources, said first bit indicating whether a first channel characteristic value associated with the first resource exceeds the threshold, the first channel characteristic value being higher than each of other channel characteristic values associated with other resources of the plurality of resources; or
the report further indicates a second bit associated with a second resource of the plurality of resources, said second bit indicating whether a second channel characteristic value associated with the second resource exceeds the threshold, the second channel characteristic value being lower than each of the other channel characteristic values associated with the other resources.

17. The apparatus of claim 12, wherein at least one of:
the report further indicates a first bit associated with a first subset of resources of the plurality of resources, said first bit indicating whether each of first channel characteristic values associated with the first subset of resources exceeds the threshold, each of the first channel characteristic values being higher than each of other channel characteristic values associated with other resources of the plurality of resources; or
the report further indicates a second bit associated with a second subset of resources of the plurality of resources, said second bit indicating whether each of second channel characteristic values associated with the second subset of resources exceeds the threshold, each of the second channel characteristic values being lower than each of the other channel characteristic values associated with the other resources.

18. The apparatus of claim 12, wherein the report further indicates a value of the threshold.

19. The apparatus of claim 12, wherein:
the report further indicates channel characteristic values associated with a subset of the resources of the plurality of resources, each resource of the subset of resources is associated with a channel characteristic value that is lower than a reference channel characteristic value associated with a reference resource of the plurality of resources;
each channel characteristic value associated with each resource of the subset of resources corresponds to a differential value relative to: the reference channel characteristic value or a preceding channel characteristic value associated with a preceding resource of the plurality of resources; and
the processor is further configured to execute the computer-executable instructions and cause the apparatus to perform quantization of each differential value to generate a corresponding quantized value.

20. The apparatus of claim 12, further comprising at least one transceiver configured to at least one of: receive the configuration or transmit the report, wherein the apparatus is configured as a user equipment (UE).
